(19) United States
(12) Patent Application Publication
(10) Pub. No.: US 2012/0030554 A1
(43) Pub. Date: Feb. 2, 2012

(54) BOOKMARK USING DEVICE, BOOKMARK CREATION DEVICE, BOOKMARK SHARING SYSTEM, CONTROL METHOD AND RECORDING MEDIUM

(76) Inventor: Tomoyuki Toya, Osaka (JP)

(21) Appl. No.: 13/254,720

(22) PCT Filed: Mar. 4, 2010
(86) PCT No.: PCT/JP2010/001522

§ 371 Date: Sep. 2, 2011

(30) Foreign Application Priority Data
Mar. 6, 2009 (JP) 2009-054232

(51) Int. Cl. G06F 17/00

(52) U.S. Cl. 715/206

(57) ABSTRACT

A bookmark using device of the present invention includes: a feature information extracting section (64) for extracting a feature information indicative of a subject of a content from a bookmark including at least (i) a content retrieval address used in retrieving the content and (ii) the feature information; and an alternative content detecting section (65) for detecting, in accordance with the extracted feature information, an alternative content whose subject is similar to or corresponds to the subject of the content from one or a plurality of content sources for supplying a content usable by the bookmark using device. This enables detecting where to retrieve an alternative content which is accessible by the bookmark using device and which corresponds to a bookmarked content.

### TECHNICAL FIELD

The present invention relates to a bookmark using device, a bookmark creation device, a bookmark sharing system, a control method, a control program, and a recording medium, each of which is used for sharing, among different devices, a content and a bookmark referencing the content.

### BACKGROUND ART

In order to find a desired scene or page efficiently when reproducing a content such as a moving image or in order to find an interrupted portion efficiently when an interrupted content is reproduced again, a conventional content reproduction device has a function of assigning a bookmark to the desired scene or page or the interrupted portion and managing the bookmark. Specifically, this function is realized by a browser function of a web browser. Bookmarks are registered by the browser function so as to be widely available.

Further, sharing such registered bookmarks and contents with other devices by transmitting the bookmarks to other devices via communication means or by uploading the bookmarks on a server on the Internet is widely made in social bookmark services etc.

For example, Patent Literatures 1 and 2 disclose a technique of sharing contents and bookmarks among a plurality of devices.

Patent Literature 1 discloses a recording and reproducing device which records a video image content and, when bookmarking a reproduction position of the recorded video content, associating the bookmark with a time when the video image content was recorded. By sharing, among a plurality of devices, the bookmark associated with the time when the video image content was recorded, other recording and reproducing devices having recorded the same video image content can reproduce the video image content directly from the position from which the recorded video image content is to be reproduced.

However, the invention of Patent Literature 1 is based on the premise that the same video image content (e.g. broadcast program) is recorded by a plurality of devices at the same time and stored therein. Accordingly, the invention of Patent Literature 1 cannot be applied to a case where individual devices acquire a content at any timing via the Internet such as IP television (IPTV) services and Video-on-Demand (VoD) and a bookmark for the content is shared by individual devices.

Patent Literature 2 discloses a system and a method in which a bookmark management server manages bookmarks, and a plurality of devices access the bookmark management server via the Internet to share bookmark information among the plurality of devices. In the technique of Patent Literature 2, URLs can be managed on the bookmark information with respect to each of the plurality of devices, and URLs which are stored in relation to individual devices are available from the bookmark information. Since each device uses an URL suitable for the type of the device, the plurality of devices can share bookmark information and contents even when displayable web page contents are different among the plurality of devices.

### CITATION LIST

### [Patent Literatures]

### [Patent Literature 1]

Japanese Patent Application Publication, Tokukai No. 2006-60867 (published on Mar. 2, 2006)

### [Patent Literature 2]

Japanese Patent Application Publication, Tokukai No. 2003-67328 (published on Mar. 7, 2003)

### SUMMARY OF INVENTION

### Technical Problem

However, the techniques of Patent Literatures 1 and 2 suffer the following problem. Specifically, in a case where it is impossible to access the content in accordance with an address such as URL included in a registered bookmark, it is impossible to deal with such a situation. If so, the bookmark is useless for a user who can share the bookmark but cannot acquire the content of interest.

An example of a case with the above situation is a case where the same content is delivered from different servers of various service providers to individual devices of users according to each user's request, such as IPTV services and VoD services. To be more specific, a user requests the server of the service provider to deliver a content. A content is owned by a copyright holder of the content, and a service provider having the right to deliver the content delivers the content. Consequently, the content is scattered in servers owned by the service providers having the right to deliver the content. Individual users request, via their devices, servers of service providers with which the users contract respectively. Accordingly, it is often that with respect to the same content, individual user's devices use different addresses when requesting the content. This results in a situation that a device having generated a bookmark can repeatedly use the bookmark, but other device which cannot receive distribution of contents from the service provider with which the user having generated the bookmark contracts or other device without the right to access the service provider cannot retrieve the content by using the bookmark.

The above problem is raised not only in the case where the contents are video images, but also in cases where the contents are music, photographs, web pages etc., provided that the contents are available via any transmission medium and the bookmark function is applicable to the contents. Further, the above problem is raised not only in the case where the contents are delivered in IPTV services or VoD services, but also in cases where the same contents such as broadcast contents, contents stored in detachable storage media, contents stored in storage media included in devices, and contents supplied via short distance communications are to be shared among a plurality of devices but routes (the kinds of services) via which the contents are acquired are different from each other

The present invention was made in view of the foregoing problem. An object of the present invention is to realize a bookmark using device, a bookmark creation device, a bookmark sharing system, a control method, and a control program, each detecting where alternative accessible contents are available which correspond to contents referenced by bookmarks, and a storage medium storing the control program.

### Solution to Problem

In order to solve the foregoing problem, a bookmark using device of the present invention includes: feature information extracting means for extracting a feature information indicative of a subject of a content from a bookmark including at least (i) a content retrieval address used in retrieving the content and (ii) the feature information; and alternative content detecting means for detecting, in accordance with the feature information extracted by the feature information extracting means, an alternative content whose subject is similar to or corresponds to the subject of the content from one or a plurality of content sources for supplying a content usable by the bookmark using device.

With the arrangement, the feature information extracting means extracts feature information from a bookmark including at least (i) a content retrieval address used in retrieving a content and (ii) feature information, and the alternative content detection means detects, in accordance with the extracted feature information, an alternative content whose subject is similar to or corresponds to the subject of the content.

Consequently, the bookmark using device can find an alternative content which is different from the original content retrievable by using the content retrieval address and which has a subject similar to or corresponding to the subject of the original content.

In order to solve the foregoing problem, a bookmark creation device of the present invention includes: content retrieval means for retrieving a content from a content source which supplies a content usable by the bookmark creation device; feature information generating means for generating, from the content retrieved by the content retrieval means, feature information indicative of a subject of the content; and bookmark generating means for generating a bookmark including at least (i) a content retrieval address used when the content retrieval means retrieves the content and (ii) the feature information generated by the feature information generating means.

With the arrangement, the bookmark creation device transmits, to a bookmark using device, a bookmark referencing a content in combination with feature information indicative of the subject of the content. Accordingly, even if the bookmark using device which is the user of the bookmark cannot use the content referenced by the bookmark, the bookmark using device can estimate the subject of the bookmarked content based on the feature information. That is, the bookmark using device can use the feature information as a clue for searching for another content whose subject is similar to the bookmarked content.

In order to solve the foregoing problem, a method of the present invention for controlling a bookmark using device is a method for controlling a bookmark using device which uses a bookmark including at least (i) a content retrieval address used in retrieving a content and (ii) feature information indicative of a subject of the content, the method including the steps of: (a) extracting the feature information from the bookmark; and (b) detecting, in accordance with the feature information extracted in the step (a), an alternative content whose subject is similar to or corresponds to the subject of the content from one or a plurality of content sources for supplying a content usable by the bookmark using device.

A method of the present invention for controlling a bookmark creation device includes the steps of: (a) retrieving a content from a content source which supplies a content usable by the bookmark creation device; (b) generating, from the content retrieved in the step (a), feature information indicative of a subject of the content; and (c) generating a bookmark including at least (i) a content retrieval address used when the content is retrieved in the step (a) and (ii) the feature information generated in the step (b).

### ADVANTAGEOUS EFFECTS OF INVENTION

In order to solve the foregoing problem, a bookmark using device of the present invention includes: feature information extracting means for extracting a feature information indicative of a subject of a content from a bookmark including at least (i) a content retrieval address used in retrieving the content and (ii) the feature information; and alternative content detecting means for detecting, in accordance with the feature information extracted by the feature information extracting means, an alternative content whose subject is similar to or corresponds to the subject of the content from one or a plurality of content sources for supplying a content usable by the bookmark using device.

In order to solve the foregoing problem, a bookmark creation device of the present invention includes: content retrieval means for retrieving a content from a content source which supplies a content usable by the bookmark creation device; feature information generating means for generating, from the content retrieved by the content retrieval means, feature information indicative of a subject of the content; and bookmark generating means for generating a bookmark including at least (i) a content retrieval address used when the content retrieval means retrieves the content and (ii) the feature information generated by the feature information generating means.

Consequently, the present invention enables detecting where to retrieve an accessible alternative content whose subject is similar to a bookmarked content. Thus, the present invention enables dealing with a situation where the bookmarked original content cannot be accessed.

### BRIEF DESCRIPTION OF DRAWINGS

FIG. 1

FIG. 1 is a block diagram showing a configuration of a main part of a user-side television 2 in a bookmark sharing system 100 of the present invention.

FIG. 2

FIG. 2 is a block diagram showing a configuration of a main part of a creator-side television 1 in the bookmark sharing system 100 of the present invention.

FIG. 3

FIG. 3 is a drawing schematically showing a configuration of the bookmark sharing system 100 in accordance with an embodiment of the present invention.

FIG. 4

FIG. 4 is a drawing schematically showing a data structure of a content in accordance with the present embodiment.

FIG. 5

FIG. 5 is an example of a bookmark management table for managing bookmarks generated by a bookmark generating section 25 of the creator-side television 1.

FIG. 6

FIG. 6 is a drawing specifically showing a main part of a bookmark d5 which is generated by the creator-side television 1 and then registered in the bookmark management server 7.

FIG. 7

FIG. 7 is a drawing specifically showing another example of a main part of the bookmark d5 which is generated by the creator-side television 1 and then registered in the bookmark management server 7.

FIG. 8

FIG. 8 is a drawing showing a specific example of an alternative content list stored in an alternative content list storage section 82 of the user-side television 2.

FIG. 9

FIG. 9 is a drawing showing a specific example of the list of candidates of content zones in an alternative content, which list is stored in the reproduction position information storage section 83 of the user-side television 2.

FIG. 10

FIG. 10 is a drawing showing a specific example of an update proposal bookmark d15 (alternative bookmark) generated by a bookmark update request section 68 of the user-side television 2.

FIG. 11

FIG. 11 is a drawing showing a specific example of an updated bookmark d16 obtained by the mobile phone 3 updating the bookmark d5 in accordance with the update proposal bookmark d15 shown in FIG. 10.

FIG. 12

FIG. 12 is a sequence drawing showing a flow of processes of individual devices when the bookmark sharing system 100 generates a bookmark and registers the bookmark.

FIG. 13

FIG. 13 is a flowchart showing a flow of a bookmark generating process S8 in FIG. 12 carried out by the creator-side television 1.

FIG. 14

FIG. 14 is a sequence drawing showing a flow of processes of individual devices when a bookmark uploaded to the bookmark management server 7 is used in the bookmark sharing system 100.

FIG. 15

FIG. 15 is a flowchart showing a process flow of use of bookmark shown in FIG. 14 carried out by the user-side television 2.

FIG. 16A

FIG. 16A is a drawing showing a specific example of content-related information on a musical program content reproduced by the creator-side television 1.

FIG. 16B

FIG. 16B is a drawing showing an example of layout information for specifying an output layout for content-related information.

FIG. 17

FIG. 17 is a drawing showing a specific example of a display screen of the creator-side television 1 when the musical program content and content-related information are reproduced, and how a user viewing the content registers a bookmark at that time.

FIG. 18

FIG. 18 is a drawing showing another specific example of a bookmark registered in the bookmark management server 7.

FIG. 19

FIG. 19 is a drawing showing a specific example of a display screen of the user-side television 2 which displays an alternative content by using the bookmark.

FIG. 20

FIG. 20 is a drawing showing an example of a display screen of the user-side television 2 which displays the result of searching for similar contents.

FIG. 21

FIG. 21 is a block diagram showing a configuration of a main part of the creator-side television 1 in a case where the bookmark management server 7 generates a bookmark.

FIG. 22

FIG. 22 is a block diagram showing a configuration of a main part of the bookmark management server 7 which generates a bookmark.

FIG. 23A

FIG. 23A is a drawing schematically showing a data structure of a bookmark generating request generated by the request generating section 27 of the creator-side television 1.

FIG. 23B

FIG. 23B is a drawing showing a specific example of a bookmark generating request generated according to an HTTP POST method.

FIG. 23C

FIG. 23C is a drawing showing a specific example of a response to the bookmark generating request, which response is generated according to the HTTP POST method.

FIG. 24

FIG. 24 is a drawing showing how a user viewing a content registers a bookmark when the bookmark management server 7 generates the bookmark, and examples of display screens displayed by display sections of the creator-side television 1 and the mobile phone 3 at that time.

### DESCRIPTION OF EMBODIMENTS

### First Embodiment

The following explains embodiments of the present invention with reference to drawings. The same members and components in individual embodiments are given the same reference signs, and have the same names and the same functions, and so detailed explanations thereof are not reiterated. It should be noted that the embodiments below are merely examples and the present invention is not limited to the embodiments below.

In the following, an explanation is made as to a case where a bookmark creation device and a bookmark using device are applied to a television. Here, each television also serves as a content reproducing device capable of receiving and reproducing digital contents such as video images via the Internet. In the present embodiment, a creator-side television serving as a bookmark creation device and a user-side television serving as a bookmark using device share a bookmark via the Internet, thereby forming a bookmark sharing system of the present invention.

### [Summary of Bookmark Sharing System]

The bookmark sharing system in the present embodiment is basically as follows. Content service providers distribute, via their respective content distribution servers, contents to televisions (clients) owned by service subscribers according to requests. A television capable of generating a bookmark (creator-side television) can generate a bookmark for a content received and reproduced by the television. The bookmark generated by the television is stored, in combination with content identification information etc., in a bookmark management server accessible by the television and managed by the bookmark management server. This enables a plurality of televisions capable of using a bookmark (user-side television) to share the bookmark.

The bookmark includes reproduction position information indicative of where to start reproducing the content. Consequently, each television can reproduce, using the bookmark generated by other television, the content at a reproduction position equal to that of the other television. Herein, reproduction of a content from a bookmarked reproduction position is referred to as resume reproduction. The reproduction position information in the present invention may be a one that specifies, as the reproduction position, one point of a position to start reproduction of the content, or may be a one that specifies a reproduction zone starting at the content reproduction starting position and ending at a content reproduction ending position, and regards the reproduction zone as the reproduction position. Further, the reproduction position information included in one bookmark may be arranged such that it consists of plural sets of the reproduction starting position and the reproduction ending position, and a plurality of reproduction zones are specified as reproduction positions. A data structure and specific examples of the reproduction position information will be explained below.

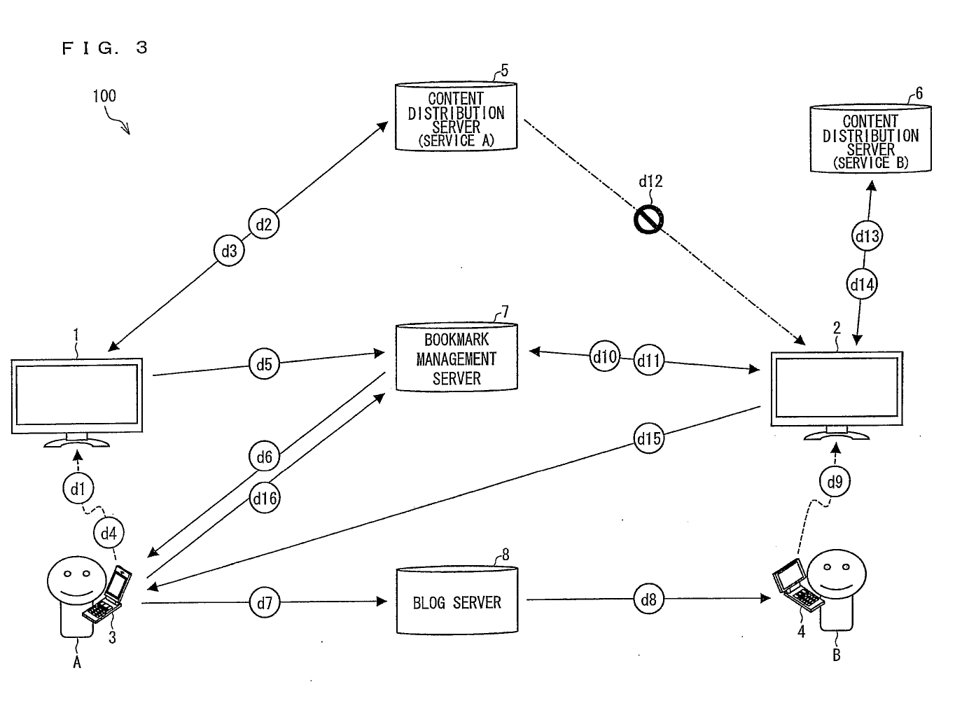

A specific configuration of the bookmark sharing system will be detailed later with reference to FIG. 3.

### [Object and Purpose of Bookmark Sharing System of the Present Invention]

For example, assume as follows: a first content service provider distributes a live broadcasting content via a first IPTV service and a certain television owned by a subscriber of the first IPTV service (creator-side television) receives and reproduces the live broadcasting content. The creator-side television generates a bookmark at a certain reproduction position of the content. Thereafter, other television (the user-side television) tries to view the live broadcasting content by using the bookmark generated by the creator-side television.

If a second content service provider to which the user-side television subscribes provides a VoD service in an archive, the user-side television may view the content by using the bookmark. However, if not so, then the user-side television must request a VoD service or a home server of a second content service provider different from the first IPTV service to deliver the content. Consequently, a bookmark which references the address of the content (address of first content distribution server) generated while the content was reproduced is meaningless to the user-side television.

In order to solve the problem, it is required for the creator-side television to generate a bookmark in such a manner that when the user-side television cannot use the address referenced by the bookmark, the user-side television can search other content (hereinafter “alternative content”) similar to or equal to the content of interest. That is, it is required for the creator-side television to have a function of generating a bookmark in such a manner that feature information suggesting or showing the content referenced by the bookmark or a reproduction position referenced by the bookmark (hereinafter “feature information”) is generated and incorporated into the bookmark in order that the user-side television can search for an alternative content for the content of interest. Further, it is required for the user-side television to have a function of, when finding it unable to use the bookmark generated by the creator-side television, searching a service to which the user-side television subscribes or all storage media accessible by the user-side television for the alternative content with reference to the feature information included in the bookmark. It is desirable for the user-side television to further have a function of specifying a reproduction position of the alternative content which is similar to that of the content of interest.

Further, it is desirable that when the user-side television finds the alternative content available (and reproduction position of the alternative content) as above, the user-side television develops the bookmark of interest by adding a bookmark referencing the alternative content to the bookmark of interest so that the bookmark referencing the alternative content is sharable with other user-side televisions. By doing so, when other user-side television which tries to use the bookmark of interest do not have the function of searching for the alternative content available, it is possible for the other user-side television to use the bookmark (as the number of alternative contents increases, unspecified number of television users are more likely to use the bookmark of interest).

The following details a specific example of the bookmark sharing system of the present invention for achieving the above object.

### [Configuration of Bookmark Sharing System]

FIG. 3 is a drawing schematically showing a configuration of a bookmark sharing system 100 in accordance with the embodiment of the present invention. As shown in FIG. 3, the bookmark sharing system 100 at least includes a creator-side television 1, a user-side television 2, a content distribution server 5, a content distribution server 6, and a bookmark management server 7. In the present embodiment, the bookmark sharing system 100 further includes a mobile phone 3, a mobile phone 4, and a blog server 8. These devices are communicably connected with one another via communication networks such as the Internet (and further via mobile phone networks in case of the mobile phones 3 and 4).

It should be noted that the bookmark sharing system 100 shown in FIG. 3 is an example for explaining the bookmark sharing system of the present invention, and is not intended to limit the present invention.

The content distribution server 5 supplies a service A to subscribers. Specifically, the content distribution server 5 distributes contents to subscribers' televisions (clients) in response to requests of the subscribers' televisions. The content distribution server 5 has an authentication function of analyzing a content requesting message sent from a client via a communication network and determining whether the client has the right to receive the content (i.e. whether the client is a subscriber or not).

For example, a user A contracts with a service provider which manages the service A via the content distribution server 5, and becomes a subscriber of the service A. The content distribution server 5 supplies, to the creator-side television 1 of the user A, a user ID and a password which are information for authenticating the user A as a subscriber of the service A. The creator-side television 1 stores therein the user information (user ID and password). Consequently, the creator-side television 1 is allowed to access the content distribution server 5 and to receive and reproduce a stream of a video content.

An example of the service A supplied by the content distribution server 5 is an IPTV service which distributes IPTV contents to subscribers such as the creator-side television 1. In this case, the content distribution server 5 is an IPTV server.

The creator-side television 1 is a television used by the user A, and receives and reproduces a content distributed by the content distribution server 5 with which the user A has contracted. Further, the creator-side television 1 can receive an Electronic Program Guide (EPG) supplied from the content distribution server 5.

Further, the creator-side television 1 has a function of generating a bookmark which references a content reproduced by the creator-side television 1. The bookmark includes various information regarding the content (e.g. title, genre, names of performers), reproduction position information (elapsed time), and information added by a viewer (e.g. keyword, comment). A data structure of a bookmark and how a bookmark is generated are detailed later. A bookmark generated by the creator-side television 1 is registered in the bookmark management server 7 so that the bookmark is sharable with other televisions connected with the bookmark management server 7.

The mobile phone 3 is a mobile phone owned by the user A. In the present embodiment, the mobile phone 3 has not only the function of a normal mobile phone but also a remote control function to serve as a remote controller for the creator-side television 1 by carrying out infrared communications with the creator-side television 1. Specifically, the remote control function is realized by providing the mobile phone 3 with remote control application software which uses an infrared communication function for outputting a television-operating remote control signal. Thus, the mobile phone 3 can be used similarly with a normal television remote controller. The remote control signal outputted from the mobile phone 3 may be the same as a conventional and publicly known remote control signal outputted from a television remote controller etc. Alternatively, the mobile phone 3 may be designed such that a thumbnail image file of a content includes, in its header region, data for remotely controlling viewing of the content and the thumbnail image file is transmitted as a remote control signal.

The bookmark management server 7 provides a user with a bookmark sharing service. Specifically, the bookmark management server 7 includes a bookmark database for storing bookmarks, manages the bookmarks, and accepts uploading and downloading of the bookmarks. In the present embodiment, in order to use the bookmark sharing service of the bookmark management server 7, each television user is required to make a user registration on the bookmark management server 7. Specifically, user registration is made in such a manner that addresses of user's television and mobile phone are stored in the bookmark management server 7 in combination with a user ID and a password.

The bookmark management server 7 accepts, from the creator-side television 1, uploading of a bookmark generated by the creator-side television 1 of a registered user A. In the upload, user authentication may be made using a user ID and a password. In the present embodiment, a bookmark is an XML (eXtensible Markup Language) file. Using an HTTP protocol, the bookmark is uploaded to the bookmark management server 7 realized by an HTTP server. Alternatively, in another embodiment, the creator-side television 1 stores a content image at a bookmarked reproduction position as a thumbnail image (image data) in a JPEG (Joint Photographic Experts Group) format, and a bookmark described in the XML format is incorporated into a header region of the thumbnail image. The creator-side television 1 may upload the thumbnail image to the bookmark management server 7.

In the present embodiment, when registration of the bookmark is completed, the bookmark management server 7 sends, to the user A, a response which is bookmark address information indicative of location where the bookmark was registered (hereinafter “bookmark URL”). The bookmark management server 7 may send the bookmark URL to the creator-side television 1 of the user A. In the present embodiment, the bookmark management server 7 sends the bookmark URL to the mobile phone 3 via e-mail.

In the present embodiment, the bookmark uploaded as above is allowed to be published to unspecified number of people. Alternatively, various embodiments are possible. For example, a registered user may designate a person to which distribution of the bookmark is allowed, or authentication information (password) for bookmark reference may be set so that only a person who knows the password can access.

The blog server 8 provides a user with a blog service. Specifically, the blog server 8 stores data of a blog generated by the registered user, and publishes the blog to unspecified number of users connected with the blog server 8.

In the present embodiment, the user A can cause the bookmark URL supplied from the bookmark management server 7 to be uploaded to the blog server 8 via the mobile phone 3. In the present embodiment, upload to the blog server 8 is made in such a manner that an edited document is attached to an e-mail. This is only an example and the present invention is not limited to this. Any method may be employed as long as a blog article to which the bookmark URL owned by the mobile phone 3 is inserted can be uploaded to the blog server 8.

When the blog article is uploaded to the blog server 8, unspecified number of users who can browse blogs on the blog server 8 can use the link to access the bookmark of the bookmark management server 7. Thus, the bookmark generated by the user A can be published to more number of users, so that more number of users can use the bookmark.

Other examples of the method for the user A to spread the bookmark generated by the user A include a method for transmitting the bookmark to other users via e-mail. For example, the user A may introduce the bookmark to other users (e.g. user B) by sending e-mail with a bookmark URL to a mailing list of a group such as people having the same hobby and friends.

The bookmark URL having been spread by appropriate means such as the blog server 8 may catch attention of a user (user B) interested in the same subject.

The content distribution server 6 provides subscribers with a service B. Specifically, as with the content distribution server 5, the content distribution server 6 distributes contents in response to requests of subscribers' televisions (clients). Further, as with the content distribution server 5, the content distribution server 6 may have a user authentication function.

An example of the service B supplied by the content distribution server 6 is a VoD service which provides subscribers with contents via VoD archive distribution. In this case, the content distribution server 6 is a VoD server having a VoD archive distribution function.

The user-side television 2 is a television used by the user B, and receives and reproduces a content distributed by the content distribution server 6. Further, the user-side television 2 accesses the bookmark management server 7 in accordance with the bookmark URL retrieved by the user B, retrieves the bookmark from the bookmark management server 7, and carries out resume reproduction of the content using the bookmark.

The user-side television 2 further has a function of, when finding it unable to access the address of the content referenced by the bookmark and to use the bookmark, detecting an alternative content available similar to or equal to the bookmarked content. Preferably, the user-side television 2 further has a function of generating a new bookmark for the alternative content. Use of the bookmark and updating the bookmark will be detailed later.

The situation where the user-side television 2 is unable to use the bookmark is, for example, as follows. The user B is a subscriber of the service B, but not a subscriber of the service A. Consequently, the user B cannot view and listen the content of the service A which is supplied by the content distribution server 5. That is, the user-side television 2 cannot retrieve the content distributed by the content distribution server 5. The user-side television 2 can retrieve the content distributed by the content distribution server 6. Another example of the situation where the user-side television 2 is unable to use the bookmark is a case where the user B is not within the service providing range due to difference in country between the user A and the user B, and so the user B is unable to access the content distribution server 5 or to subscribe to the content distribution server 5. Alternatively, since the content distribution server 5 and the content distribution server 6 provide different services, some television cannot reproduce the content distributed by these servers (specifically, since the IPTV service does not provide a function of Video-on-Demand (VoD) archive distribution, there is a case where a user cannot view and listen the content). As above, various situations are conceivable.

The mobile phone 4 is a mobile phone owned by the user B. In the present embodiment, as with the mobile phone 3 of the user A, the mobile phone 4 has a remote control function for remotely operating the user-side television 2. The user B can operate the mobile phone 4 in order to instruct the user-side television 2 to retrieve a bookmark or to carry out resume reproduction using the bookmark.

The above devices constitute the bookmark sharing system 100. The following briefly explains give and receive of data/signal and a flow of a process in the bookmark sharing system 100 in order to share a bookmark by the method of the present invention.

### [Flow of Data in Bookmark Sharing System]

The mobile phone 3 sends a content reproduction instruction signal d1 to the creator-side television 1 via infrared communications. d1 includes content identification information etc. for specifying a content. d1 can be sent in such a manner that, for example, the user A browses on the creator-side television 1 an Electronic Program Guide supplied from the content distribution server 5, operates the mobile phone 3, selects a content, and presses a key for specifying reproduction.

The creator-side television 1 requests the content distribution server 5 to distribute the content specified by the mobile phone 3. That is, the creator-side television 1 transmits a content request message d2 to the content distribution server 5. Upon reception of the content request message d2, the content distribution server 5 makes authentication and then distribute a requested content d3 to the creator-side television 1. The creator-side television 1 reproduces a content d3.

When the user A presses a bookmark button (not shown) on GUI (Graphical User Interface) on remote control application of the mobile phone 3 while the creator-side television 1 reproduces the content d3, the mobile phone 3 transmits a bookmark registration signal d4 to the creator-side television 1. The bookmark registration signal d4 is a signal for informing the creator-side television 1 of timing to generate a bookmark (timing to determine reproduction position of content in reproduction). The creator-side television 1 incorporates address information (URL) of the content in the content distribution server 5, and if necessary content identification information, into the bookmark. Further, the creator-side television 1 retrieves a reproduction position at which a reproduction section of the creator-side television 1 outputs the content when the creator-side television 1 receives the bookmark registration signal d4. Specifically, when the starting position of the content is 00: 00: 00, information indicative of a time relatively elapsed from the starting position is retrieved as reproduction position information to be bookmarked.

In the example shown in FIG. 3, the bookmark registration signal d4 is transmitted once. Alternatively, the mobile phone 3 may transmit the bookmark registration signal d4 twice with a predetermined interval. The creator-side television 1 may determine the position to start bookmarking the content in response to the first bookmark registration signal, and display on its screen a message such as “press bookmark button again at position to end bookmaking”. When the creator-side television 1 receives the bookmark registration signal again while displaying the message, the creator-side television 1 determines the position to end bookmarking, and incorporate the position to start bookmarking and the position to end bookmarking into the bookmark. At that time, the creator-side television 1 may display a message such as “bookmark is recorded”.

Then, the creator-side television 1 incorporates feature information regarding the bookmarked content or the bookmarked reproducing position into the bookmark and thus complete the bookmark (which will be detailed later). The creator-side television 1 transmits the bookmark and a registration request message d5 to the bookmark management server 7 and requests the bookmark management server 7 to register the bookmark.

Upon reception of the request to register the bookmark from the creator-side television 1, the bookmark management server 7 registers the bookmark of d5 in the bookmark database. When the registration is completed, the bookmark management server 7 transmits, to the mobile phone 3 owned by the user A of the creator-side television 1, a bookmark URL of the registered bookmark and a registration completion notification d6 via e-mail etc.

The user A retrieves the bookmark URL of d6 via the mobile phone 3, generates a blog article d7 including the bookmark URL on the mobile phone 3, and uploads the blog article d7 to the blog server 8.

The blog article d7 published on the blog server 8 can be browsed by the user B with the mobile phone 4. The user B can search blogs supplied from the blog server 8 for a blog in accordance with the user B's taste, so as to browse a blog meeting the conditions. The user B browses the blog article of d7, and when the user B is interested in the content referenced by the bookmark, the user B can operate the mobile phone 4 so as to download a linked bookmark URL d8 from the blog server 8 to the mobile phone 4.

When the mobile phone 4 receives the bookmark URL in a predetermined format, infrared transmission remote control application is started up, and a message for inquiring a user whether to transmit the received bookmark URL as a remote control signal or not may be displayed. When the user B enters into the mobile phone 4 an instruction to transmit the bookmark URL to the user-side television 2, the mobile phone 4 transmits, to the user-side television 2 via infrared communications, the bookmark URL and a resume reproduction instruction signal d9 for instructing the user-side television 2 to carry out resume reproduction in accordance with the bookmark.

The user-side television 2 accesses the bookmark management server 7 in accordance with the bookmark URL received from the mobile phone 4, and requests the bookmark management server 7 to send a bookmark corresponding to the bookmark URL. The user-side television 2 transmits a bookmark request message d10 to the bookmark management server 7. The bookmark management server 7 supplies a corresponding bookmark d11 to the user-side television 2 in response to the request.

In accordance with address information and reproduction position information for the content included in the received bookmark d11, the user-side television 2 tries to retrieve the content from the content distribution server 5.

When the user-side television 2 cannot retrieve the content of interest in accordance with the address information included in the bookmark d11 for the above reason (e.g. when receiving a distribution disapproval notification d12 from the content distribution server 5), the user-side television 2 searches for an alternative content based on feature information of the present invention (which will be detailed later)

In a case where other method for retrieving the content is not found (alternative content is not found), the content distribution server 5 may supply, to the user-side television 2, the distribution disapproval notification d12 and a URL of a page for subscribing to the service A. In some embodiments, if the user-side television 2 can enroll on-line in the service A of the content distribution server 5, the user-side television 2 may enroll in the service A and make registration so as to enable a user to view the content referenced by the bookmark.

In accordance with the feature information, the user-side television 2 finds an alternative content available by the user-side television 2 from the content distribution server 6 with which the user-side television 2 has contracted. The user-side television 2 transmits, to the content distribution server 6, an alternative content request message d13 for requesting the content distribution server 6 to distribute the alternative content which the user-side television 2 has found. In response to this message, the content distribution server 6 makes authentication if necessary, and distributes the requested alternative content d14 to the user-side television 2. Thus, the user-side television 2 can reproduce an alternative content d14.

Further, it is desirable that the user-side television 2 is designed such that the user-side television 2 can specify an alternative reproduction position of the alternative content in such a manner that the alternative reproduction position exactly corresponds to the reproduction position of the content referenced by the unavailable bookmark. Further, it is desirable that the user-side television 2 develops the unavailable bookmark by adding the bookmark referencing the alternative content to the unavailable bookmark. For example, the user-side television 2 may enable the user B to specify the alternative position (alternative reproduction position information) while the user-side television 2 reproduces the alternative content. The user B operates a bookmark button registration button on the remote control application of the mobile phone 4 while viewing the alternative content on the user-side television 2. The user-side television 2 generates a bookmark referencing the alternative content similarly with when the creator-side television 1 generates a bookmark. That is, the user-side television 2 adds address information of the alternative content and the reproduction position of the alternative content which is specified by the user B to the bookmark of interest, so as to generate an update proposal bookmark d15 (alternative bookmark). The user-side television 2 transmits the update proposal bookmark d15 to the mobile phone 3 of the user A who is a creator of the bookmark of interest and proposes updating of the bookmark of interest.

The user A who is a creator of the bookmark of interest reviews the additional part of the update proposal bookmark d15 transmitted from the user-side television 2, and if the user A considers that the additional part may be added as information regarding the new content and the reproduction position thereof to the bookmark of interest, the user A accesses the bookmark management server 7 and transmits a bookmark update request message d16 as well as the updated bookmark, thereby formally updating the bookmark of interest.

As described above, in the bookmark sharing system 100 of the present invention, even if the user-side television 2 cannot access the server storing the content based on the address information referenced by the bookmark generated by the creator-side television 1 (even if the user-side television 2 cannot receive and reproduce the content), the user-side television 2 can deal with such a situation by indicating where to retrieve an alternative content available. Further, by specifying a reproduction position of the alternative content which position substitutes for the reproduction position of the original content referenced by the bookmark and adding information on the alternative content to the original bookmark, it is possible to develop the original bookmark so that more number of users can use the original bookmark.

The following details respective configurations and respective operations of the creator-side television 1 and the user-side television 2 and a data structure of a bookmark.

For convenience of explanation, in the following explanation, the user A's television which generates an original bookmark is considered as the creator-side television 1 and the user B's television which tries to use the original bookmark is considered as the user-side television 2. However, the creator-side television 1 may serve as a user-side television which uses a bookmark generated by other television. the user-side television 2 may serve as a creator-side television which newly generates a bookmark.

### [Configuration of Creator-Side Television]

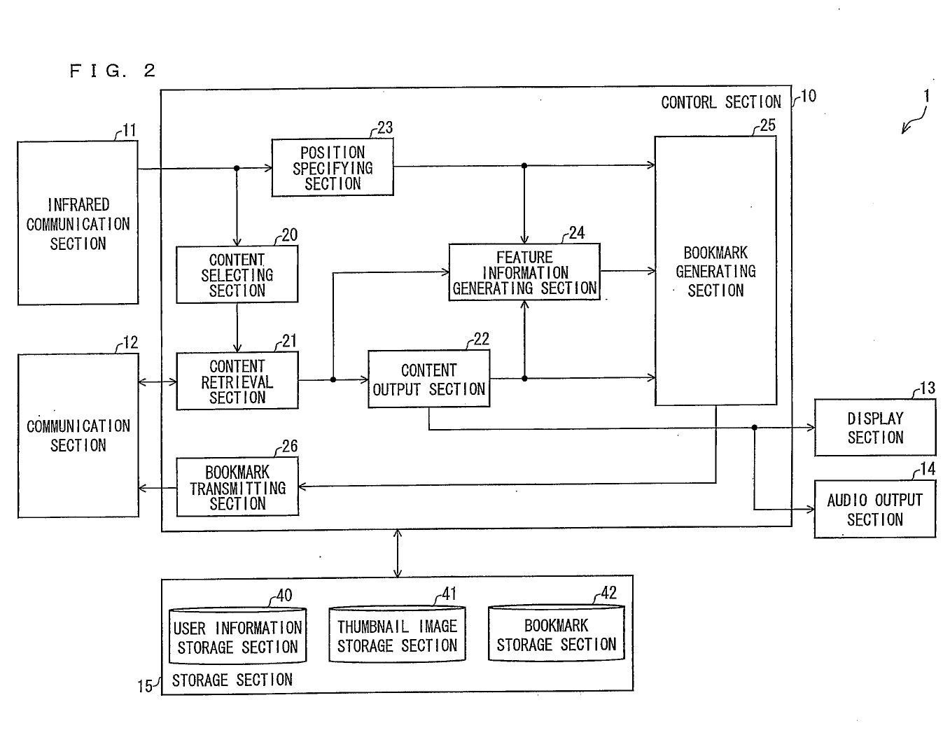

FIG. 2 is a block diagram showing a configuration of a main part of the creator-side television 1 in the bookmark sharing system 100 of the present invention. In the present embodiment, the creator-side television 1 is an IPTV (Internet Protocol TeleVision) terminal having a network function.

As shown in FIG. 2, the creator-side television 1 which generates a bookmark includes a control section 10, an infrared communication section 11, a communication section 12, a display section 13, an audio output section 14, and a storage section 15.

The infrared communication section 11 receives a signal transmitted in the form of infrared ray from the mobile phone 3. The infrared communication section 11 is made of light-receiving means (infrared communication port) which receives infrared ray from the mobile phone 3. The signal received by the infrared communication section 11 is classified into a bookmark registration signal for instructing the creator-side television 1 to generate a bookmark and other signal. When receiving the bookmark registration signal, the infrared communication section 11 transmits the received signal to a position specifying section 23.

The communication section 12 communicates with an external device using appropriate communication means for wireless/wired communications via a communication network such as the Internet.

The display section 13 displays an image or video image in accordance with output instructions from the control section 10. For example, the display section 13 may be an LC (Liquid Crystal) display panel, a plasma display panel, or an EL (Electro Luminescence) display panel.

The audio output section 14 outputs audio in accordance with output instructions from the control section 10. For example, the audio output section 14 may be a speaker.

The storage section 15 stores (i) a control program executed by the control section 10, (ii) an OS program executed by the control section 10, and (iii) various data to be read out when the control section 10 executes various functions of the creator-side television 1. For example, the storage section 15 may be a storage device such as a flash memory. In particular, the storage section 15 stores various programs and data to be read out when the creator-side television 1 executes a bookmark sharing application. Specifically, the storage section 15 includes a user information storage section 40, a thumbnail image storage section 41, and a bookmark storage section 42.

The control section 10 centrally controls the operation of the creator-side television 1. For example, the control section 10 may be made of CPU (Central Processing Unit) etc. The control section 10 operates using a temporal storage section (not shown) made of a RAM (Random Access Memory) etc. as a working area. The control section 10 includes, as functional blocks, a content selecting section 20, a content retrieval section 21, a content output section 22, the position specifying section 23, a feature information generating section 24, a bookmark generating section 25, and a bookmark transmitting section 26. These functional blocks are realized by the CPU (Central Processing Unit) reading out a program from the storage device (storage section 15) made of a ROM (Read Only Memory) to a RAM (Random Access Memory) (not shown) etc. and executing the program.

The content selecting section 20 specifies a content designated as a content to be reproduced. Specifically, an Electronic Program Guide supplied from the content distribution server 5 which provides an IPTV service etc. is displayed on the display section 13 in the form of GUI (Graphical User Interface), and the content selecting section receives, from the mobile phone 3 via the infrared communication section 11, a signal for designating a content, and specifies a content. The content selecting selection 20 supplies to the content retrieval section 21 content identification information of the specified content so as to inform the content retrieval section 21 of the content to be retrieved.

To be specific, seeing the Electronic Program Guide displayed on the display section 13, the user A operates the mobile phone 3 and selects a content and presses a determination button etc. so as to transmit a content reproduction instructing signal d1 from the mobile phone 3 to the creator-side television 1. When receiving the content reproduction instructing signal d1 designating the content, the content selecting section 20 specifies content identification information corresponding to the designated content in the Electronic Program Guide and outputs the specified content identification information to the content retrieval section 21. In the present embodiment, the content identification information may be an viewing request address which is given by the content distribution server 5 and which is used for retrieving the content.

Using the viewing request address supplied from the content selecting section 20, the content retrieval section 21 requests the content distribution server 5 to distribute the desired content, and retrieves the desired content from the content distribution server 5. Specifically, the content retrieval section 21 sends, to the viewing request address of the content distribution server 5, user information (e.g. user ID, password) retrieved at the time of contract and stored in the user information storage section 40, so as to retrieve a content retrieval address, port information, and authentication information used for retrieving the desired content. Using such information, the content retrieval section 21 accesses the content distribution server 5 and starts to receive streaming of the desired content.

In the present embodiment, the content retrieval section 21 firstly sends to the viewing request address a request for service use (content viewing) including authentication information, and if authentication is made, the content retrieval section 21 receives, as a response of the authentication, a content retrieval address which is a direct address used in retrieving a content. However, the present invention is not limited to this embodiment. For example, in a simple embodiment in which authentication is not required, the content retrieval section 21 may retrieve a desired content simply based on one content retrieval address without discriminating a viewing request address and a content retrieval address.

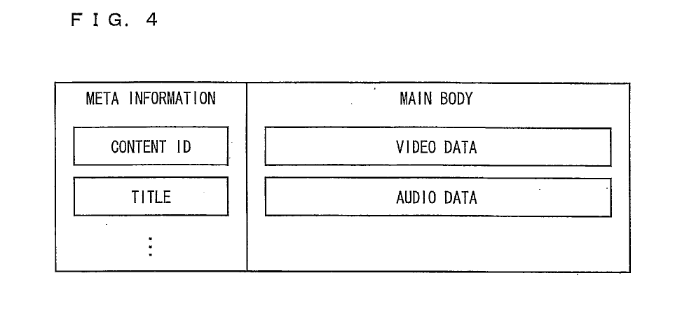

In the present embodiment, as shown in FIG. 4, the content retrieved by the content retrieval section 21 includes (i) meta-information (title, content identification information, information on performers, summary of content, name of provider, copyright information etc.) in the form of digital data and (ii) a content body consisting of video data and audio data. The content retrieval section 21 supplies the meta-information out of the retrieved content to the feature information generating section 24, and supplies the content body (video data and audio data) to the content output section 22. The content retrieval section 21 is made of, for example, a modulator, a TS decoder, etc. The modulator modulates and corrects the content in accordance with the form of signals of the content. The TS decoder decodes the multiplexed content, and separates the content into a TS packet including video signal and audio signal and a TS packet including meta-information signals of the content.

The content output section 22 decodes, using a codec, the content received by the content retrieval section 21, and outputs the video data to the display section 13 and the audio data to the audio output section 14. The content output section 22 is made of an AV decoder for example. The AV decoder decodes the former TS packet, generates an audio signal and a video signal, and outputs the audio signal to the audio output section 14 and the video signal to the display section 13.

The position specifying section 23 receives via the infrared communication section 11 a bookmark registration signal transmitted from the mobile phone 3, and instructs the bookmark generating section 25 and the feature information generating section 24 to generate a bookmark. Specifically, the position specifying section 23 informs the bookmark generating section 25 and the feature information generating section 24 of timing at which the creator-side television 1 received a bookmark registration signal, and causes the bookmark generating section 25 and the feature information generating section 24 to specify the reproduction position of the content which position corresponds to the timing. In the present embodiment, the bookmark registration signal is sent twice at the beginning and ending of the bookmarked position. Accordingly, the position specifying section 23 determines whether the received bookmark registration signal indicates the beginning of the bookmark or the ending of the bookmark and then causes the bookmark generating section 25 and the feature information generating section 24 to specify the reproduction position of the content which position corresponds to the timing.

The feature information generating section 24 generates feature information indicative of the subject of the content and the reproduction position thereof which the feature information generating section 24 is instructed via the mobile phone 3 to bookmark. The feature information generating section 24 may generate the feature information based on video data and audio data of the content body at the reproduction position of the content, or based on meta-information given to the content.

In detail, the feature information generating section 24 initially specifies a content zone which was outputted by the content output section 22 from a time when the feature information generating section 24 received a bookmark starting position signal from the position specifying section 23 to a time when the feature information generating section 24 received a bookmark ending position signal. Then, the feature information generating section 24 generates feature information retrieved from video data and audio data in the content zone.

The feature information generating section 24 generates feature information on a content or a reproduction position thereof, based on image data and/or text information of the content at a certain reproduction position (starting position or ending position) of the content zone. Specifically, the feature information generating section 24 downsizes an image of the content at the certain reproduction position of the content zone so as to generate a thumbnail image, and/or subjects images of the content zone to an image process so as to extract a character sequence, and/or subjects the audio data of the content zone to an audio recognition process so as to extract a character sequence, and/or extracts meta-information (title of content, summary of content, information on performers etc.) given to the content. The feature information generating section 24 may extract meta-information associated with a content in the Electronic Program Guide supplied in advance from the content distribution server 5 independently of the content.

Examples of the character sequence extracted by the feature information generating section 24 from the video data or the audio data are as follows: in a case where the content is a sport program, the feature information generating section 24 may subject character information on matching teams and scores, superimposed texts etc. included in individual image data constituting video data to a character recognition process so as to extract the character information as text information. In a case where the content is a movie, the feature information generating section 24 may extract a character sequence from audio data or captions. The image process for extracting feature information may be supported by a hardware chip such as GPU (Graphics Processing Unit) or realized by software. As for the image process and the audio process for extracting feature information, techniques for extracting characters on images and techniques for generating texts from audio data are in practical use in many ways. Since such techniques are not the essence of the present invention, specific explanations of the techniques are omitted here.

The feature information generating section 24 generates a thumbnail image from the content outputted by the content output section 22 at specified timing, and causes the thumbnail image to be stored in the thumbnail image storage section 41 of the storage section 15. The feature information generating section 24 causes the thumbnail image to be stored in the thumbnail image storage section 41 in such a manner that the thumbnail image is given a file name and is associated with a content retrieval address, reproduction position information (time) etc. This allows the bookmark generating section 25 for generating a bookmark to easily associate a bookmark with the content and the reproduction position.

There are some methods for determining a reproduction position of the content at which a thumbnail image is to be extracted and stored.

The feature information generating section 24 may extract, as a thumbnail image, an image of the content at a time when the bookmark registration signal was received, and cause the thumbnail image to be stored. Alternatively, the feature information generating section 24 may extract a thumbnail image at a marker such as a chapter given in advance to a certain reproduction position of the content. Alternatively, the feature information generating section 24 extracts thumbnail images continuously at a predetermined interval and detects whether a change in character sequence retrieved from the thumbnail images exists or not, and when a change in character sequence exists, the feature information generating section 24 causes a thumbnail image at the time of the change to be stored in the thumbnail image storage section 41. Further, a character sequence retrieved from the thumbnail image at the time of the change may be treated as feature information.

The feature information generating section 24 supplies, to the bookmark generating section 25, the feature information thus generated on the content or the reproduction position in the bookmark.

The bookmark generating section 25 generates a bookmark in such a manner that the bookmark is associated with the content and the reproduction position thereof which the bookmark generating section 25 is instructed via the mobile phone 3 to bookmark. At that time, the bookmark generating section 25 incorporates the feature information generated by the feature information generating section 24 into the bookmark. In particular, the bookmark generating section 25 incorporates, into the bookmark, content feature information on the content in such a manner that the content feature information is associated with the content, and incorporates, into the bookmark, reproduction position feature information on a reproduction position of the content in such a manner that the reproduction position feature information is associated with the reproduction position.

When receiving the bookmark starting signal or the bookmark ending signal from the position specifying section 23, the bookmark generating section 25 retrieves the elapsed time of the content outputted by the content output section 22 at timings indicated by the bookmark starting signal and the bookmark ending signal respectively. The elapsed time may be a relative elapsed time since the start of the content as “00: 00: 00”. And the bookmark generating section 25 regards the elapsed times thus retrieved (starting position of bookmark and ending position of bookmark) as reproduction position information.

The bookmark generating section 25 generates a bookmark at least including (i) a content retrieval address for identifying a content in reproduction when the bookmark generating section 25 is instructed to generate a bookmark, (ii) information on the reproduction position of the content which is specified based on a bookmark starting/ending position signal, (iii) feature information generated by the feature information generating section 24 on the content or the reproduction position thereof, and (iv) user information (user ID, password, mail address of the mobile phone 3 etc.) stored in the user information storage section 40.

The bookmark generating section 25 shapes the bookmark thus generated so that the bookmark is in a data format for an XML document or other form, and sends the bookmark to the bookmark transmitting section 26. The bookmark generating section 25 may cause the generated bookmark to be stored in the bookmark storage section 42.

The bookmark generating section 25 specifies the reproduction position in one of the following ways.

For example, the bookmark generating section 25 may be arranged so as to monitor a change in information on images constituting the content, detect a time point when scenes change, and correct a bookmark starting position from mistimed timing actually designated by a user to the detected time point where scenes change. Alternatively, the bookmark generating section 25 may be arranged so as to detect a change in text information (character sequence) which is known from the thumbnail images generated by the feature information generating section 24 so as to estimate timing which the user really intended to designate and correct the book mark starting position accordingly. Alternatively, the bookmark generating section 25 may be arranged so as to specify, as reproduction position information, a time point which is a predetermined time (e.g. three sec.) before the reproduction position corresponding to the timing at which the bookmark starting signal or the bookmark ending signal was received.

For example, there is a possibility that although the user A wants to bookmark the current scene while viewing a live broadcasting program, the user A cannot immediately take the mobile phone 3 and send a bookmark registration signal, and consequently a bookmark starting position is delayed. This problem is solved by the above arrangement in such a manner that the creator-side television 1 absorbs such delay of timing so as to enable generating a bookmark at a bookmark starting position which the user A really intends.

The bookmark transmitting section 26 transmits, to the bookmark management server 7, the bookmark generated by the bookmark generating section 25 and the registration request message d5 so as to request the bookmark management server 7 to register the bookmark.

Using various user information stored in the user information storage section 40, the bookmark transmitting section 26 uploads the bookmark to the bookmark management server 7. The user information storage section 40 stores various information on the user (user information). For example, the user information storage section 40 stores (i) the IP address and model information of the creator-side television 1 owned by the user A, and (ii) the mail address of the mobile phone 3 owned by the user A. Further, the user ID and the password assigned to the user A with respect to each service provider are stored in relation to the service provider. For example, the user ID and the password used when registering a bookmark in the bookmark management server 7 are stored in relation to the bookmark management server 7, and the user ID and the password used when requesting the content distribution server 5 to distribute contents are stored in relation to the content distribution server 5.

In the present embodiment, the bookmark transmitting section 26 starts uploading the bookmark to the bookmark management server 7 using authentication information (user ID and password) which are stored in the user information storage section 40 in relation to the bookmark management server 7.

In the above embodiment, an explanation was made as to an example in which the creator-side television 1 generates a bookmark with respect to a content retrieved from the content distribution server 5. However, the creator-side television 1 of the present invention is not limited to this, and may generate a bookmark with respect to a content retrieved from any content source which supplies a content available by the creator-side television 1. Examples of the content source include: an external device connectable with the creator-side television 1 via the Internet, such as the content distribution server 5 with which the user A who owns the creator-side television 1 contracts; a recording device, a home server etc. with which the creator-side television 1 is connected via a domestic LAN; an external storage medium attachable to the creator-side television 1, such as a USB (Universal Serial Bus) flash drive; and a storage device built in the creator-side television 1, such as a HDD.

### [Bookmark Management Table]

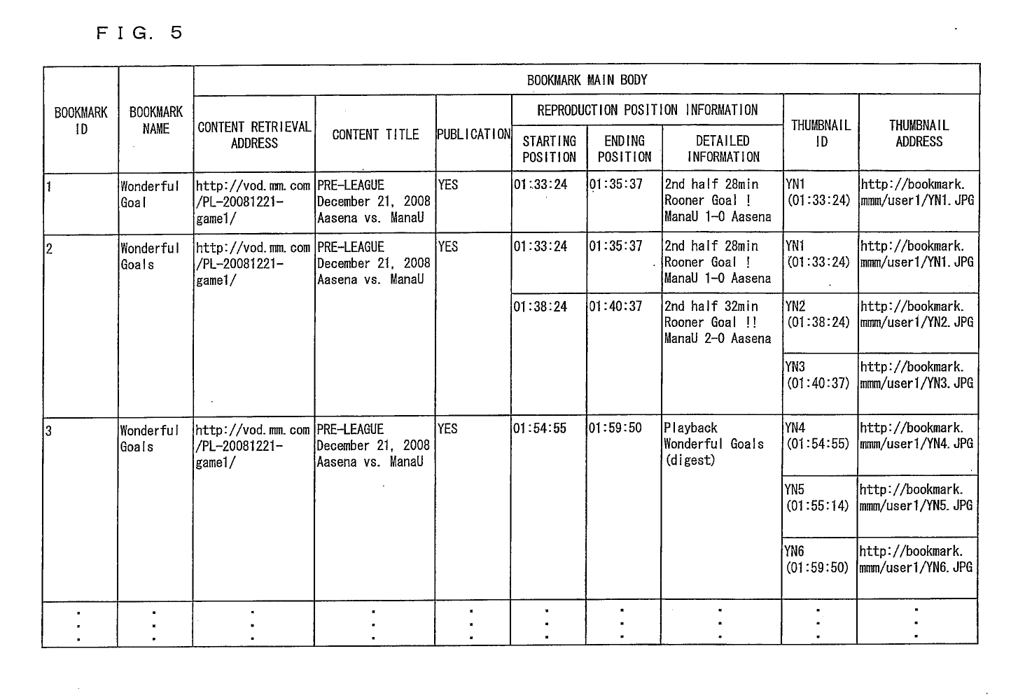

FIG. 5 is an example of a bookmark management table for managing bookmarks generated by the bookmark generating section 25. The bookmark management table is stored in the bookmark storage section 42.

With respect to each bookmark, one bookmark ID is stored in relation to a bookmark name and a bookmark body (various information included in the bookmark).

The column “bookmark ID” is used for uniquely identifying bookmarks. Each time the bookmark generating section 25 generates a bookmark, the bookmark ID is automatically assigned to the bookmark in order to avoid duplication of the bookmark. The column “bookmark name” indicates the names of the bookmarks, and can be freely given to the bookmarks in order to facilitate the user's management.

The column “content retrieval address” indicates a location where contents are stored. URLs of the contents are stored therein for example. In the present embodiment, the content retrieval address is also used as content identification information for uniquely specifying a content. Further, information for specifying a provider to supply the content may be included in the content retrieval address.

The column “content title” is the title of the content which was given to the content in advance. The content title is extracted by the feature information generating section 24 from the Electronic Program Guide or meta-information of distributed contents, and is stored in the bookmark management table.

The column “publication” indicates whether the bookmark is allowed to be published to unspecified number of people or not when the bookmark is uploaded to the bookmark management server 7. An instruction to publish the bookmark or not may be inputted by the user A operating the mobile phone 3 into the bookmark generating section 25 of the creator-side television 1.

“starting position” in the column “reproduction position information” indicates a reproduction starting position of the content referenced by the bookmark. “ending position” indicates a reproduction ending position of the content. “detailed information” in the column “reproduction position information” indicates explanations or comments on the content zone which starts with the “starting position” and ends with the “ending position”. The “detailed information” may be a text extracted by the feature information generating section 24 based on an image and audio in the content zone and stored, or may be inputted and stored comments which the user wants to make regarding the content zone. Further, the “reproduction position information” may have a data structure only with the value of the “starting position”. In this case, the “detailed information” may include explanations or comments on the video image of the content at the “starting position”.

The column “thumbnail ID” indicates identification information for uniquely identifying the thumbnail image generated by the feature information generating section 24. For example, a file name assigned to a thumbnail image when the feature information generating section 24 generates the thumbnail image may be stored in this column. Further, time information indicating a reproduction position of the content at which the thumbnail image is positioned may be stored.

The column “thumbnail address” stores the URL of the thumbnail image when the thumbnail image is published. The bookmark management server 7 may determine where to store the thumbnail image, and inform the creator-side television 1 of the URL of the thumbnail image. After the creator-side television 1 is informed by the bookmark management server 7 of the URL of the thumbnail image, the feature information generating section 24 of the creator-side television 1 may retrieve, as feature information to be incorporated into the bookmark, the URL indicative of the location of the thumbnail image instead of the thumbnail image itself and inform the bookmark generating section 25 of the URL.

As shown in FIG. 5, one possible embodiment is that one content zone is specified with respect to one bookmark, and one thumbnail image is generated with respect to the content zone (see bookmark ID: “1”). Another possible embodiment is that two content zones are specified with respect to one bookmark. Further another possible embodiment is that two thumbnail images are generated at the beginning and ending of one content zone, respectively (see bookmark ID: “2”). Further another possible embodiment is that a thumbnail image is generated at any time point other than the beginning and ending of one content zone (see bookmark ID: “3”).

It should be noted that all the columns are not required to store values before and after the bookmark generating section 25 generates a bookmark. As for information assigned by the bookmark management server 7 to a bookmark after the bookmark is uploaded to the bookmark management server 7, some values may be stored in the columns after notification of the bookmark management server 7. The configuration of the bookmark management table shown in FIG. 5 is merely an example, and is not intended to limit the configuration of the creator-side television 1 of the present invention.

### [Data Structure of Bookmark]

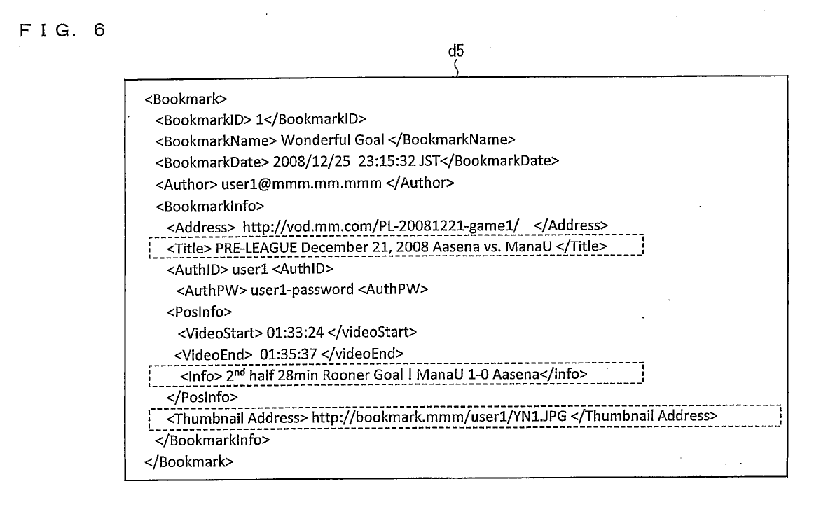

FIG. 6 is a drawing specifically showing a main part of the bookmark d5 which is generated by the creator-side television 1 and then registered in the bookmark management server 7. The bookmark shown in FIG. 6 is the bookmark with the bookmark ID: “1” in FIG. 5 in the form of an XML document.

As shown in FIG. 6, components constituting the bookmark are shown hierarchically using tags in the XML document just like the components are managed in the bookmark management table shown in FIG. 5.

<BookmarklD> corresponds to the “bookmark ID” in FIG. 5. In the present embodiment, since the bookmark management server 7 manages bookmarks with respect to each user, the creator-side television 1 freely assigns sequential numbers to the bookmarks. Alternatively, the bookmark management server 7 may generate bookmark IDs as global identifiers associated with services and user information.

<BookmarkName> is a name given to the bookmark in order that a human can identify the bookmark, and corresponds to the “bookmark name” in FIG. 5. In the present embodiment, a predetermined bookmark name such as “new bookmark” is assigned to a default bookmark name, and it is supposed that later a user accesses the bookmark management server 7 and edits the default bookmark name.

<BookmarkDate> indicates a date when the bookmark was generated.

<Author> is information for identifying a user who has generated a bookmark. In the present embodiment, the mail address of the mobile phone 3 of the user A is described. The mail address, which is registered in the user information storage section 40 in advance, is read by the bookmark generating section 25 and is inserted between the tags. Another possible embodiment is that by incorporating, into a signal transmitted from a mobile phone serving as a remote controller, an ID used for identification of a mobile phone, it is possible to set an author with respect to each mobile phone.

A part between tags in <BookmarkInfo> corresponds to the “bookmark body” in FIG. 5. <Address> is a communication address used in requesting the content. In the present embodiment, <Address> is written in the form of URL, and corresponds to the “content retrieval address” in FIG. 5.

<Title> is a title of a content, and corresponds to the “content title” in FIG. 5. When selecting a content on the Electronic Program Guide, title information of program information in the Electronic Program Guide is inserted. An example using titles in more detail is that additional information is added to title information in the Electronic Program Guide. Specifically, the feature information generating section 24 may combine an ID of a soccer game program with the date of the game, information on which team is playing where, and the starting time of the game in order to generate a title of a content used in a bookmark.

<AuthID> and <AuthPW> are user authentication information (user ID and password) used for retrieving content data, and such authentication information is read out from the user information storage section 40 and inserted. In general, since such authentication information is confidential contract information, such authentication information is not inserted. However, if the bookmark of interest is an unpublished bookmark used only by a person who has generated the bookmark, such authentication information may be inserted as shown in the drawing.

<PosInfo> indicates a reproduction position in a content, and corresponds to the “reproduction position information” in FIG. 5. In the present embodiment, since the content is video data, a content zone (beginning time and ending time) to be bookmarked is set based on time information in the video data, and when carrying out bookmark reproduction, this content zone is resume-reproduced. Among sub-components of <PosInfo>, <VideoStart> corresponds to the “starting position” in FIG. 5, <VideoEnd> corresponds to the “ending position” in FIG. 5, and <Info> corresponds to the “detailed information” in FIG. 5.

<Thumbnail Address> is image data or audio data generated from output data of the content at timing when the content was bookmarked, and a storage location of a thumbnail image is described. <Thumbnail Address> corresponds to the “thumbnail address” in FIG. 5. When a bookmark is generated, a thumbnail image is captured by the feature information generating section 24 and then is stored in the bookmark management server 7. In the example shown in FIG. 6, the URL of the thumbnail image stored in the bookmark management server 7 is described here.

In the bookmark shown in FIG. 6, components indicated by broken lines between tags in <BookmarkInfo> are regarded as feature information. In particular, the <Title> component is feature information on the content, and the <Info> component and the <Thumbnail Address> component are feature information on the reproduction position.

As described above, it is possible to insert a bookmark into the header region of the thumbnail image file so that the mobile phone 3 and the creator-side television 1 can cooperatively use the bookmark. One possible example is that a user reviews the thumbnail image on the creator-side television 1 and then reproduces a moving image of the bookmarked content zone.

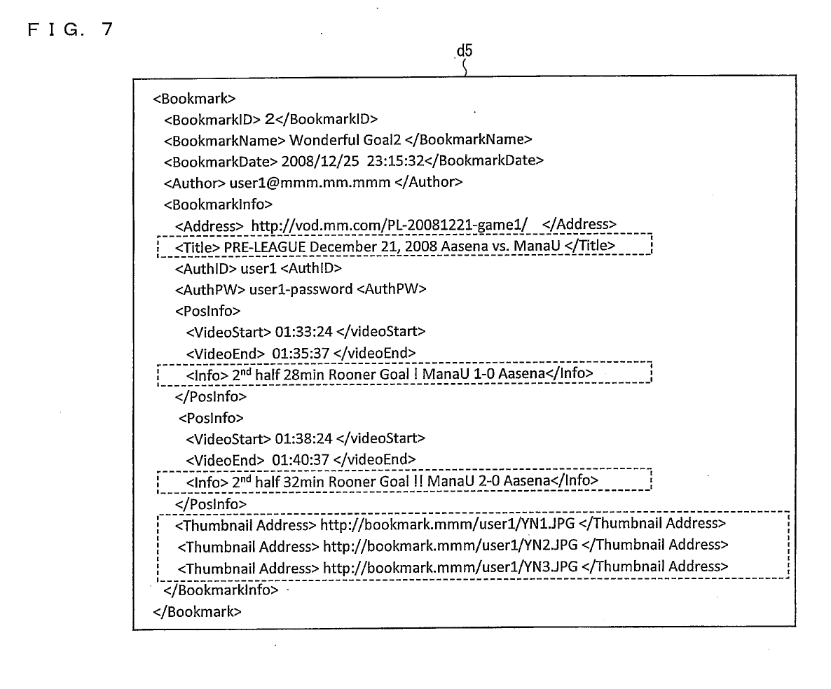

FIG. 7 is a drawing specifically showing a main part of the bookmark d5 which is generated by the creator-side television 1 and then registered in the bookmark management server 7. The bookmark in FIG. 7 is the bookmark with the bookmark ID: “2” in FIG. 5 in the form of an XML document. That is, in the bookmark in FIG. 6, one content zone is specified as a reproduction position, whereas in the bookmark in FIG. 7, a plurality of content zones are associated as a reproduction position with one bookmark.

The bookmark in which a plurality of content zones are included as reproduction positions is generated (i) by the user A further operating plural times the bookmark registration signal of the mobile phone 3 or (ii) combining a plurality of content zones to generate one bookmark. For example, in a case where a user wants to make a digest of a content such as a movie and a television drama, it is convenient to generate such a bookmark including a plurality of content zones.

The bookmark in FIG. 7 is different from the bookmark in FIG. 6 in that one <BookmarkInfo> component includes a plurality of <PosInfo> components. In the example shown in FIG. 7, one bookmark corresponds to one content and to a plurality of content zones. However, the present invention is not limited to this example. A bookmark corresponding to a plurality of contents and to one content zone (or a plurality of content zones) of each content can be treated as one bookmark by the televisions and the bookmark management server 7.

In a case where a bookmark serving as a digest of content zones of a plurality of contents is generated and published to unspecified number of users, the technique of the present invention is particularly effective. The reason is as follows. In a case where a bookmark consisting of a plurality of bookmarked contents as above is used by unspecified number of users (televisions), if all the contents referenced by the bookmark cannot be retrieved by the user-side television, the user-side television cannot reproduce any of the contents referenced by the bookmark. Consequently, as one bookmark includes more number of contents, the bookmark is less likely to be used completely. However, with the present invention, even if some of (or all of) the plurality of contents cannot be used by the user-side television, the user-side television can find and use alternative contents based on feature information included in the bookmark. Accordingly, even if the bookmark includes a large number of contents, the user-side television can use the bookmark.

### [Bookmark Generating Sequence]

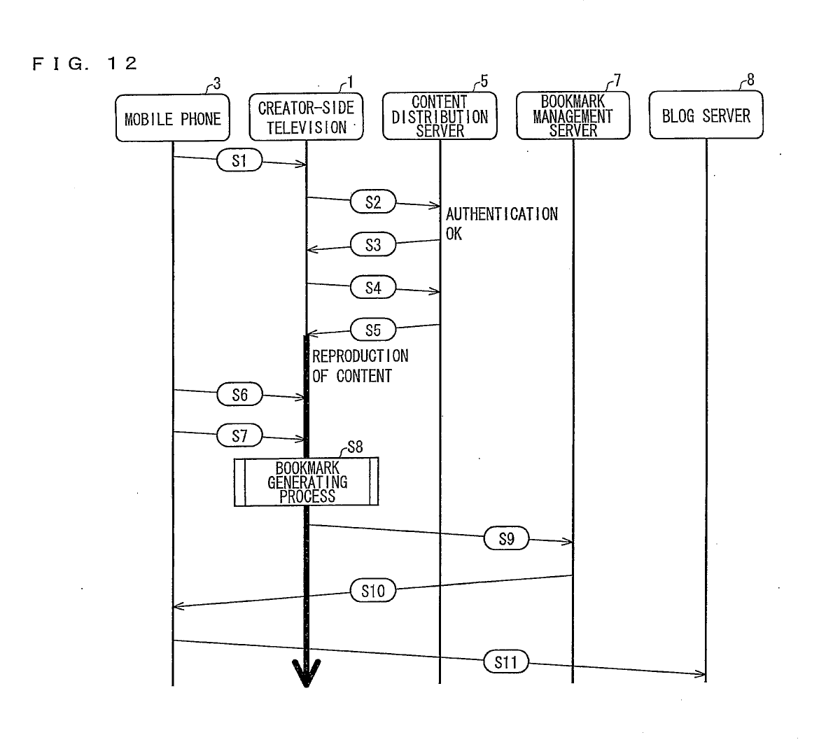

FIG. 12 is a sequence drawing showing a flow of processes of individual devices when the bookmark sharing system 100 generates a bookmark and registers the bookmark. FIG. 12 shows a case where the user A views a content selected from the Electronic Program Guide, generates a bookmark and registers it in the bookmark management server 7, receives via the mobile phone 3 the URL of the registered trademark, embeds the URL as a link in a blog generated by the mobile phone 3, and posts the blog in the blog server 8. Here, it is assumed that the user A can remotely operate the creator-side television 1 by using the mobile phone 3 as a remote controller.

Initially, while seeing the Electronic Program Guide displayed on the creator-side television 1, the user A operates the mobile phone 3 and selects a program (content). At that time, the mobile phone 3 transmits a content selecting signal doubling as a content reproduction instructing signal to the creator-side television 1 via infrared (S1). The creator-side television 1 receives the content reproduction instructing signal and carries out a program viewing request to the content distribution server 5 (IPTV viewing authentication) in response to the content reproduction instructing signal (S2). That is, the creator-side television 1 transmits a content request message to the content distribution server 5.

The content distribution server 5 examines viewing authentication information (e.g. ID, password) from the creator-side television 1, and if the authentication information matches (authentication OK), the content distribution server 5 transmits information such as a content retrieval address of the requested content to the creator-side television 1 (S3). Using information such as the received content retrieval address, the creator-side television 1 accesses the content distribution server 5 and requests the content distribution server 5 to start streaming distribution of the desired content (S4). In response to this request, the content distribution server 5 starts streaming distribution of the requested content (S5). Consequently, the creator-side television 1 can reproduce the content.

While the creator-side television 1 reproduces the content, the user A operates the mobile phone 3 and designates a position (starting point and ending point) which the user A wants to bookmark. In response to this operation, the mobile phone 3 generates a bookmark registration signal in the form of an infrared signal, and transmits the bookmark registration signal to the creator-side television 1. To be more specific, the mobile phone 3 transmits a bookmark starting position signal (S6) and a bookmark ending position signal (S7) to the creator-side television 1 via infrared.

When receiving the bookmark starting signal and the bookmark ending signal, the creator-side television 1 generates a bookmark so that a content zone of the content in reproduction, which is designated by the signals, can be resume-reproduced. At that time, the creator-side television 1 incorporates feature information associated with the content and/or reproduction position (content zone) into the bookmark (bookmark generating process in S8). The creator-side television 1 uploads the generated bookmark to the bookmark management server 7 (S9).

The bookmark management server 7 causes the received bookmark to be stored in the bookmark database, and transmits, to the mobile phone 3 of the user A via e-mail, a notification of registration of the bookmark and a bookmark URL indicative of a location where the bookmark is stored (S10). The bookmark management server 7 manages the creator-side television 1 having uploaded the bookmark in S9 and the mail address of the mobile phone 3 of the user A in such a manner that the creator-side television 1 and the mail address of the mobile phone 3 are associated with the user ID etc. of the user A.

When the mobile phone 3 receives the bookmark URL, the user A operates the mobile phone 3, generates a blog article including the bookmark URL and uploads the blog article to the blog server 8 so that the bookmark is published to unspecified number of users (S11).

Thus, the bookmark including feature information is shared.

### [Flow of Bookmark Generating Process]

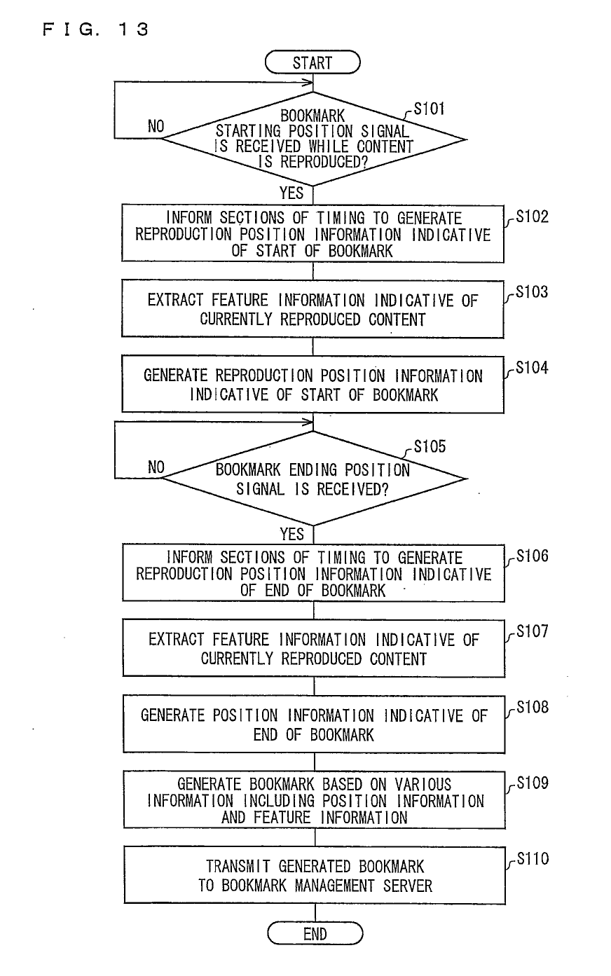

FIG. 13 is a flowchart showing a flow of the bookmark generating process S8 in FIG. 12 carried out by the creator-side television 1.

While the creator-side television 1 reproduces the content, the position specifying section 23 of the creator-side television 1 wait for input of a bookmark starting position signal via the infrared communication section 11 (S101). When receiving the bookmark starting position signal (YES in S101), the position specifying section 23 transmits, to the bookmark generating section 25, timing at which reproduction position information of the bookmark starting point is generated for the content in reproduction (S102). The position specifying section 23 may transmits the timing to the feature information generating section 24.

In accordance with timing at which the bookmark starting position signal is inputted from the position specifying section 23 or the bookmark generating section 25, the feature information generating section 24 extracts feature information on the content in reproduction (S103). Specifically, with respect to the content outputted by the content output section 22, the feature information generating section 24 may retrieve from the content retrieval section 21 text information such as a title included in the Electronic Program Guide or meta-information on the content, or may capture a thumbnail image from video frames outputted by the content output section 22 and generate text information from the thumbnail image or audio data. Alternatively, the thumbnail image itself may be treated as feature information. The feature information generating section 24 may cut out, as an image, a video frame outputted at the bookmark starting position, so as to generate a thumbnail image. Further, timing to generate a thumbnail image is not limited to the starting position, and a thumbnail image may be generated at a predetermined interval after the starting position or at a time point when scenes change. Further, a scene at a predetermined time before the starting position may be a thumbnail image.

Receiving timing to generate reproduction position information indicative of a position at which a bookmark starts, the bookmark generating section 25 retrieves the elapsed time in reproduction of the content (relative elapsed time since the start of the content as “00: 00: 00”) outputted from the content output section 22, and generates the reproduction position information indicative of the position at which the bookmark starts (S104).

Subsequently, the position specifying section 23 waits for a bookmark ending position signal to come from the mobile phone 3 via the infrared communication section 11 (S105). When receiving the bookmark ending position signal (YES in S105), the position specifying section 23 transmits, to the bookmark generating section 25, timing to generate reproduction position information on position at which bookmark ends (S106). At that time, the position specifying section 23 may transmit the timing to the feature information generating section 24.

In accordance with the timing received from the position specifying section 23 or the bookmark generating section 25, the feature information generating section 24 extracts feature information on the content zone outputted from the starting position to the ending position (S107). The feature information generating section 24 may cut out, as an image, a video frame outputted at the bookmark ending position, so as to generate a thumbnail image.

Receiving the timing to generate reproduction position information on position at which bookmark ends, the bookmark generating section 25 retrieves an elapsed time in reproduction of the content outputted from the content output section 22, and generates the reproduction position information on position at which bookmark ends (S108).

The order of S103 carried out by the feature information generating section 24 and S104 carried out by the bookmark generating section 25 is not particularly limited. Further, the order of S107 and S108 is not particularly limited. S103 and S104 may be carried out in parallel, and S107 and S108 may be carried out in parallel.

The bookmark generating section 25 generates a bookmark at least including the reproduction starting position information and the reproduction ending position information generated in S104 and S108 and the feature information generated by the feature information generating section 24 (S109).

The bookmark transmitting section 26 transmits, to the bookmark management server 7, the bookmark generated by the bookmark generating section 25 and necessary authentication information (S110).

### [Configuration of User-Side Television]

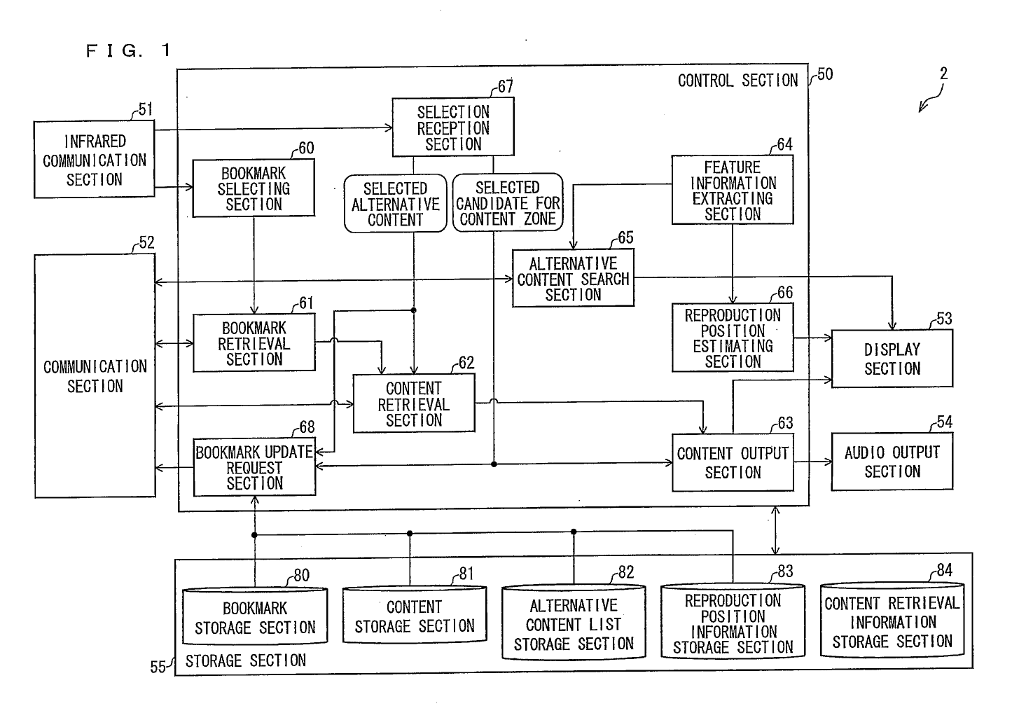

FIG. 1 is a block diagram showing a configuration of a main part of the user-side television 2 in the bookmark sharing system 100 of the present invention. In the present embodiment, the user-side television 2 is an IPTV (Internet Protocol TeleVision) terminal having a network function.

As shown in FIG. 1, the user-side television 2 includes a control section 50, an infrared communication section 51, a communication section 52, a display section 53, an audio output section 54, and a storage section 55.

The infrared communication section 51 receives a signal from the mobile phone 4 via infrared. The infrared communication section 51 includes light-receiving means (infrared communication port) for receiving infrared from the mobile phone 4. When the received signal is a resume reproduction instructing signal d9 including a bookmark, the infrared communication section 51 transmits the resume reproduction instructing signal d9 to a bookmark retrieval section 61, and when the received signal is a bookmark retrieving instructing signal including a bookmark URL, the infrared communication section 51 transmits the bookmark retrieving instructing signal to the bookmark selecting section 60. Further, as for a signal inputted when the user B selects via the mobile phone 4 one of items selectably displayed on the display section 53 in the form of GUI, the infrared communication section 51 transmits the signal as a selectable item specifying signal to a selection reception section 67.

The communication section 52, the display section 53, and the audio output section 54 have the same functions as those of the communication section 12, the display section 13, and the audio output section 14, respectively.

The storage section 55 stores (i) a control program executed by the control section 50, (ii) an OS program executed by the control section 50, and (iii) various data to be read out when the control section 50 executes various functions of the user-side television 2. The storage section 55 includes a storage device such as a flash memory. In particular, the storage section 55 stores various program and data to be read out when the user-side television 2 executes a bookmark sharing application. Specifically, the storage section 55 includes a bookmark storage section 80, a content storage section 81, an alternative content list storage section 82, a reproduction position information storage section 83, and a content retrieval information storage section 84. The bookmark storage section 80 stores a bookmark retrieved by the bookmark retrieval section 61. The content storage section 81 stores a content/alternative content retrieved by the content retrieval section 62. The alternative content list storage section 82 stores the list of alternative contents found by an alternative content search section 65. The reproduction position information storage section 83 stores candidates of reproduction position information of a content (content zone if starting position and ending position exist). The content retrieval information storage section 84 stores information on a content source for supplying contents available by the user-side television 2. In addition, the storage section 55 may store information such as a content retrieval address of a content and the title of the content retrieved by the content retrieval section 62 in the past. Further, if authentication is required with respect to each content source, the storage section 55 may store an authentication ID and a password for the authentication.

The control section 50 centrally controls the operation of the user-side television 2. For example, the control section 50 may be made of CPU etc. The control section 50 operates using a temporal storage section (not shown) made of a RAM etc. as a working area. The control section 50 includes, as functional blocks, a bookmark selecting section 60, a bookmark retrieval section 61, a content retrieval section 62, a content output section 63, a feature information extracting section 64, an alternative content search section 65, a reproduction position estimating section 66, a selection reception section 67, and a bookmark update request section 68. These functional blocks are realized by the CPU reading out a program from the storage device (storage section 55) made of a ROM etc. to a RAM etc. (not shown) etc. and executing the program.

The bookmark selecting section 60 retrieves a bookmark URL from the mobile phone 4 via the infrared communication section 51, and supplies the bookmark URL to the bookmark retrieval section 61 so as to instruct the bookmark retrieval section 61 to retrieve a bookmark.

In the present embodiment, the bookmark URL is transmitted in the form of an infrared signal from the mobile phone 4 in such a manner that the bookmark URL is attached to a thumbnail image suggesting and expressing the content referenced by the bookmark. Accordingly, when the bookmark selecting section 60 receives the thumbnail image in the form of the infrared, the bookmark selecting section 60 extracts the bookmark URL stored in a predetermined region of the image (e.g. Exif region etc. of JPEG image), and outputs the bookmark URL to the bookmark retrieval section 61. The bookmark URL indicates a location of the bookmark management server 7 in which location the bookmark is stored.

In a case where access to the bookmark management server 7 is limited, the bookmark selecting section 60 extracts not only the bookmark URL but also authentication information (e.g. password) from the predetermined region and transmits the bookmark URL and the authentication information to the bookmark retrieval section 61.

The bookmark retrieval section 61 accesses the bookmark management server 7 via the communication section 52 and using the bookmark URL extracted by the bookmark selecting section 60, and retrieves a bookmark indicated by the URL. The bookmark retrieval section 61 causes the bookmark to be stored in a bookmark storage section 80 of the storage section 55. When the bookmark retrieval section 61 retrieves the bookmark, the bookmark retrieval section 61 requests the content retrieval section 62 to retrieve a content using the bookmark.

The content retrieval section 62 retrieves a content corresponding to the bookmark by using the content retrieval address and the authentication information which are included in the bookmark retrieved by the bookmark retrieval section 61. The content retrieval section 62 may retrieve a content from an external device via the communication section 52 or may retrieve a content stored in the storage section 55 of the user-side television 2 or in a storage medium connected with the user-side television 2.

Further, in a case where the content retrieval section cannot retrieve the content corresponding to the bookmark due to the situation as above, the content retrieval section 62 may retrieve an alternative content detected by the alternative content search section 65 or may receive user's designation of an alternative content via the selection reception section 67 and retrieve the alternative content in accordance with the user's instruction.

The content retrieval section 62 may cause the retrieved content and the retrieved alternative content to be stored in the content storage section 81 or may output the retrieved content as needed to the content output section 63 by using a transitory storage section (not shown).

Using a codec, the content output section 63 decodes the content received by the content retrieval section 62, and outputs video data to the display section 53 and audio data to the audio output section 54. The content output section 22 is made of an AV decoder for example.

The feature information extracting section 64 extracts, from the bookmark retrieved by the bookmark retrieval section 61, feature information on the content and/or reproduction position thereof. The feature information is, as described above, information which suggests and expresses the bookmarked content or reproduction position thereof and which is used in order for the user-side television 2 to estimate the content or a content zone specified by the reproduction position information. Specific examples of the feature information include the title of the content, information on performers of the content, information on captions of the content, text information extracted from audio data, character sequences extracted from video data, and thumbnail images of the content. The feature information is not limited as long as it is usable by the user-side television 2 in order to estimate the bookmarked content or the bookmarked reproduction position of the content. And the feature information may include the kind of the content, information for identifying a game in the case of sports, information on innings and scores in the case of baseball games, information on elapsed time and scores in the case of soccer games, and keywords such as lines and brand names readable from goods displayed on the screen in the case of movies and television dramas.

In the present embodiment, failure of the content retrieval section 62 to retrieve a content with reference to the original bookmark retrieved by the bookmark retrieval section 61 serves as a trigger for causing the feature information extracting section 64 to operate. The failure to retrieve the content may be informed by the content retrieval section 62 to the feature information extracting section 64 or may be detected by the feature information extracting section 64 monitoring the content retrieval section 62.

The configuration of the feature information extracting section 64 is not limited to the above. Other than the case of the failure of the content retrieval section 62 to retrieve the content, the feature information extracting section 64 may always extract feature information every time a bookmark is used, or may extract feature information at a predetermined interval, or may extract feature information for a bookmark used by a lot of users in a case where the number of users can be detected, or may extract feature information in accordance with a user's instruction made via the mobile phone 4 etc. The feature information extracting section 64 outputs feature information extracted from the bookmark to the alternative content search section 65 and the reproduction position estimating section 66.

Using feature information which the feature information extracting section 64 extracts from the bookmark, the alternative content search section 65 searches an alternative content which the user-side television 2 can browse instead of an original content corresponding to the bookmark.

Specifically, the alternative content search section 65 refers to address information etc. which is stored in the content retrieval information storage section 84 etc. and which relates to content sources in which contents browsable by the user-side television 2 are stored, and searches the content sources for a desired alternative content. The content source is not limited as long as it can store contents in such a manner that the contents are usable by the user-side television 2. Examples of the content source include: an external device connectable via the Internet, such as the content distribution server 6 with which the user B who owns the user-side television 2 contracts; a video recording device, a home server etc. with which the user-side television 2 is connected via a domestic LAN; an external storage medium attachable to the user-side television 2, such as a USB flash drive; and a storage device built in the user-side television 2, such as a HDD.

For example, when searching the content distribution server 6 for an alternative content, the alternative content search section 65 transmits the feature information as a search query to the content distribution server 6 via the communication section 52. To be more specific, using texts in the feature information as keywords, the alternative content search section 65 retrieves the list of contents including the texts in content titles, and using thumbnail images as the feature information, the alternative content search section 65 retrieves the list of contents including images similar to the thumbnail images. In this case, the content distribution server 6 has a function of detecting, from contents owned by the content distribution server 6, scenes similar to or corresponding to scenes recommended by the user A who uses other content service provider (content distribution server 5). Consequently, the content distribution server 6 can provide the user B who subscribes to the service B of the content distribution server 6 with the same scenes as those recommended by other users who are subscribers of other services. The content distribution server 6 may have a function of, in a case where the alternative content which the user-side television 2 requests the content distribution server 6 to distribute is a television drama or a movie, (i) searching the content distribution server 6 for the same or similar content based on lines of the content (caption data or audio data), (ii) identifying the scene, and (iii) supplying the content to the user-side television 2.

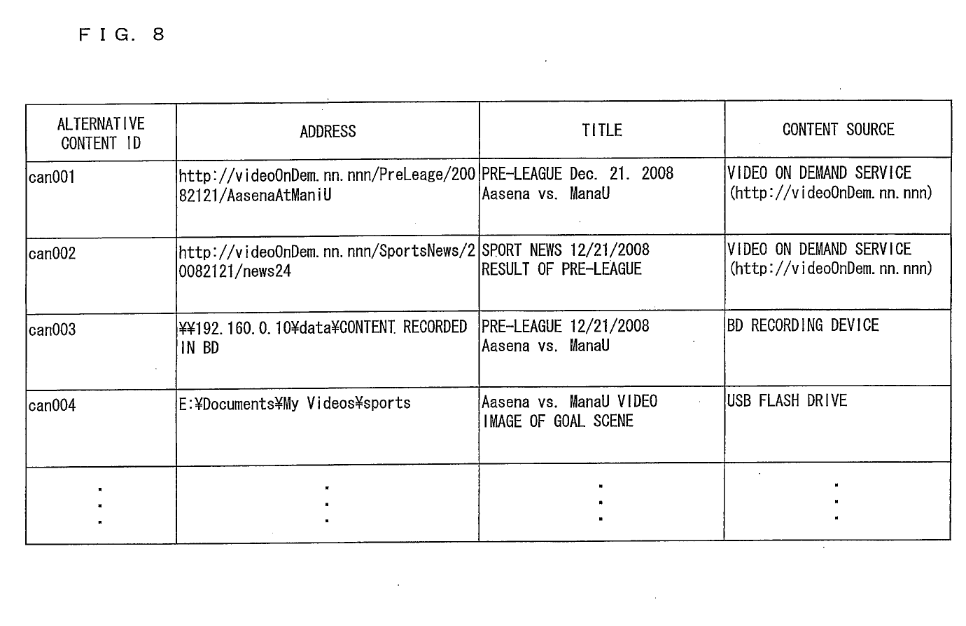

As described above, the alternative content search section 65 searches the content source usable by the user-side television 2 for an alternative content and generates an alternative content list which shows the list of candidates of alternative contents. FIG. 8 shows a specific example of the alternative content list. When the alternative content search section 65 searches using feature information as a search condition and find a plurality of alternative contents which meet the condition, the alternative content search section 65 may generate the alternative content list as shown in FIG. 8 for example and output the list to the display section 53 so that the candidates of the alternative contents are displayed in such a manner as to be selectable by a user. This allows the user B to specify a desired alternative content at the user B's own judgment. Alternatively, the alternative content search section 65 may select the most suitable alternative content out of a plurality of candidates. For example, the alternative content search section 65 may evaluate similarities between the plurality of candidates and the original content and select the most similar alternative content, or may preferentially select a free content as the alternative content. The alternative content search section 65 may cause the generated alternative content list to be stored in the alternative content list storage section 82 of the storage section 55.

FIG. 8 shows a specific example of the alternative content list stored in the alternative content list storage section 82. It should be noted that the alternative content list shown in FIG. 8 is merely an example and is not intended to limit the present invention. The alternative content list has columns “address”, “title”, and “content source” which are associated with each alternative content ID for uniquely managing the alternative content list. “address” stores a URL, a password etc. for accessing the alternative content. “title” stores the title of the content. “content source” stores the name of a device, provider etc. which stores the alternative content. The alternative content list may store, in addition to the above, information indicative of whether the alternative content is free or not, degree of similarity etc. in such a manner that the information is associated with the alternative content ID. Further, other than the “title”, information (e.g. thumbnail image) on the subject of the alternative content may be stored in relation to the alternative content.

By the display section 53 displaying such an alternative content list in order for the user to select, the user can select a more suitable bookmark referencing a content similar to or corresponding to the content referenced by the original bookmark which cannot be used by the user.

The alternative content narrowed down to one by the alternative content search section 65 or by user's selection is retrieved by the content retrieval section 62. When the reproduction position estimating section 66 estimates where a reproduction position corresponding to the reproduction position referenced by the original bookmark exists in the alternative content, the reproduction position estimating section 66 processes the alternative content.

Using the feature information extracted by the feature information extracting section 64, the reproduction position estimating section 66 estimates, in the alternative content found by the alternative content search section 65, a reproduction position similar to or corresponding to the reproduction position referenced by the original bookmark, and specifies an alternative reproduction position (alternative reproduction position information). The reproduction position estimating section 66 reads out feature information on the reproduction position from the original bookmark, and specifies, in the alternative content, one or a plurality of content zones similar to the content zone in the original content. When specifying the plurality of content zones, the reproduction position estimating section 66 may generates the list of candidates of reproduction positions and output the list to the display section 53 so that the display section 53 displays the candidates in such a manner as to be selectable by a user. Consequently, the user B can specify a desired reproduction position at the user B's judgment. Alternatively, the reproduction position estimating section 66 may determine similarity between the candidates of content zones and the reproduction position referenced by the original bookmark by using the feature information, and specify the most suitable (most similar) content zone. Further, the reproduction position estimating section 66 may cause the generated list of candidates of content zones (reproduction position information) to be stored in the reproduction position information storage section 83 of the storage section 55.

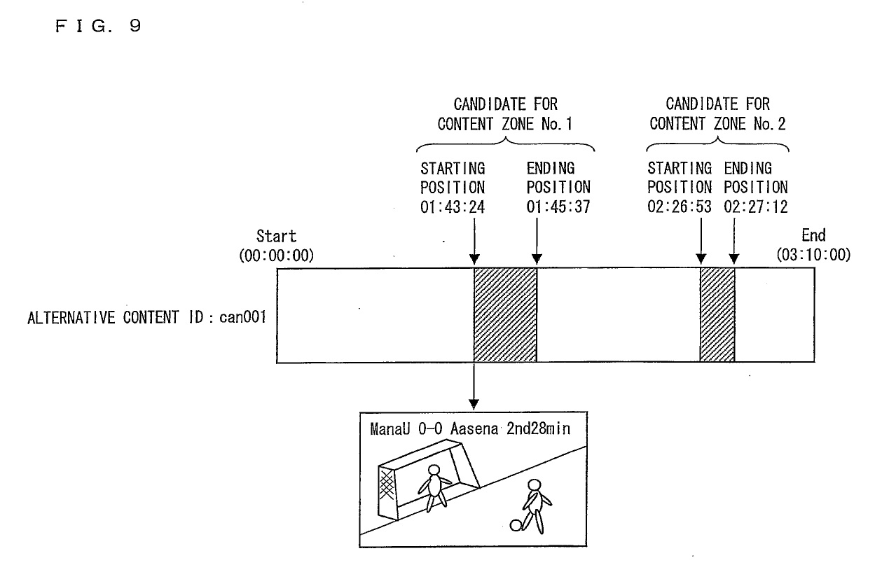

FIG. 9 is a drawing showing a specific example of the list of candidates of content zones in an alternative content. The list is stored in the reproduction position information storage section 83.

When the alternative content whose alternative content ID is “can001” is selected as the most suitable alternative content in the alternative content list shown in FIG. 8, the reproduction position estimating section 66 detects candidates of content zones in the alternative content “can001”.

With reference to FIG. 9, an explanation is made as to a specific example of a method in which the reproduction position estimating section 66 detects candidates of content zones. Here, it is assumed that the original bookmark is the bookmark d5 shown in FIG. 6.

The reproduction position estimating section 66 retrieves, from the feature information extracting section 64, feature information on a content reproduction position of the original bookmark d5. Specifically, the reproduction position estimating section 66 retrieves text information “2nd half 28 min Rooner Goal ! ManaU 1-0 Aasena” and a thumbnail image (“YN1.jpg”) at the reproduction starting position “01: 33: 24” in the <Info> component. At that time, the reproduction position estimating section 66 may also retrieve the value of “01: 33: 24” as reproduction starting position information.

Assume that the reproduction position estimating section 66 detects two content zones each including a scene similar to the thumbnail image “YN1.jpg” in the alternative content “can001”. The two content zones are, in the example shown in FIG. 9, a candidate content zone No. 1 and a candidate content zone No. 2. The reproduction position estimating section 66 may present the detected two candidate content zones to the user B so that the user B can select one of the two content zones. The user B reviews the title of the content and detailed information on the bookmarked scene which are included in the original bookmark and based on such feature information, views the candidate content zones of the alternative content, so that the user B can select a candidate content zone of the alternative content as a content zone corresponding to the original bookmark. The user B may specify the content zone (reproduction starting position and reproduction ending position) corresponding to the original bookmark via the mobile phone 4 while viewing the alternative content.

Alternatively, the reproduction position estimating section 66 may further accurately specify a similar content zone by using another feature information.

The reproduction position estimating section 66 further retrieves, from the image at the starting position of the candidate content zone No. 1, text information “ManaU 0-0 Aasena 2^{nd}28 min”. The reproduction position estimating section 66 may determine that the candidate content zone No. 1 is more similar to the content zone referenced by the original bookmark than the candidate content zone No. 2 is, because of high similarity between the text information “ManaU 0-0 Aasena 2^{nd}28 min” and the text information in the <Info> component in the original bookmark d5. Further, in a case where it may be assumed that the same scene is at substantially the same reproduction position, the reproduction position estimating section 66 may determine that the candidate content zone No. 1 whose reproduction starting position “01: 43: 24” is closest the reproduction starting position “01: 33: 24” of the original bookmark.

The above method for determining the candidate content zone is merely an example and is not intended to limit the configuration of the reproduction position estimating section 66.

When the alternative content search section 65 or the reproduction position estimating section 66 displays the list of candidates in such a manner that the candidates are selectable by the user via GUI, the selection reception section 67 receives a signal indicative of the candidate selected by the user via GUI, and transmits information on the candidate selected by the user to sections of the control section 50.

In the present embodiment, for example, the alternative content search section 65 causes the display section 53 to display a plurality of candidates of alternative contents. Then, the user B selects one of the alternative contents and presses the determination button of the mobile phone 4. The selection reception section 67 identifies the selected alternative content based on an infrared signal transmitted from the mobile phone 4 and a GUI displayed on the display section 53, and instructs the content retrieval section 62 to retrieve the alternative content. Similarly, the reproduction position estimating section 66 causes the display section 53 to display detected candidates of content zones so that the user can select one of the candidates via the mobile phone 4. The selection reception section 67 identifies the selected candidate and informs the content output section 63 of a reproduction starting position of the alternative content.

The selection reception section 67 may transmit information on the alternative content selected by the user B and a resume reproduction position (candidate content zone) thereof to the bookmark update request section 68 for updating a bookmark.

The bookmark update request section 68 requests the user A having generated the original bookmark retrieved by the bookmark retrieval section 61, to update the original bookmark. Specifically, when the alternative content search section 65 specifies the alternative content or the reproduction position estimating section 66 specifies reproduction position information instead of the alternative content, the bookmark update request section 68 generates an update proposal bookmark d15 including information on the alternative content and reproduction position thereof, and proposes adding the information to the original bookmark.

For example, in the present embodiment, in a case where the user-side television 2 cannot resume-reproduce the content in the content distribution server 5 by using the original bookmark d5, when the user-side television 2 can retrieve a similar alternative content from the content distribution server 6, the bookmark update request section 68 generates a new bookmark in the form of an XML document for resume-reproducing the alternative content and transmits the new bookmark as the update proposal bookmark d15 to the mobile phone 3 of the user A. In the present embodiment, the bookmark d5 includes the mail address of the mobile phone 3 of the user A having generated the bookmark d5. Accordingly, the user-side television 2 can transmit the update proposal bookmark d15 from the communication section 52 to the mobile phone 3.

When receiving the proposal to update the bookmark from the user-side television 2, the user A reviews the content of the update via the mobile phone 3, and if the user A approves the update, the user A updates the original bookmark d5 based on the update proposal bookmark d15, and uploads an updated bookmark d16 to the bookmark management server 7. The updated bookmark d16 includes not only URL of the content in the content distribution server 5 but also URL of the alternative content of the content distribution server 6. Therefore, the updated bookmark d16 is a bookmark which has been developed from the bookmark d5 in order that the user who cannot use the content distribution server 5 can access the content distribution server 6 and view a similar content.

Consequently, even if still another user-side television which tries to use the bookmark does not have a function of finding an alternative content viewable by the user, the still another user-side television can use the bookmark. This enables bookmark management which meets the purpose of the bookmark sharing system 100 such that unspecified number of users share the bookmark.

### [Updated Bookmark]

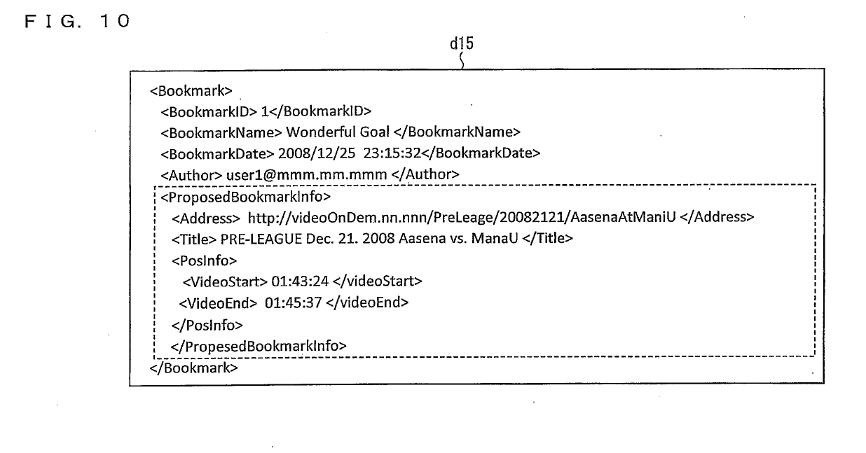

FIG. 10 is a drawing showing a specific example of the update proposal bookmark d15 generated by the bookmark update request section 68.

<ProposedBookmarkInfo> component shown by a broken line in FIG. 10 includes information on the alternative content and the alternative reproduction position as a sub-component. The <ProposedBookmarkInfo> component is a component indicative of a proposal by a person with no authority to update the original bookmark to a creator with the authority who have generated the original bookmark, which proposes addition of such a BookmarkInfo. <address> in the <ProposedBookmarkInfo> component indicates a location where the alternative content retrievable from the content distribution server 6 is stored.

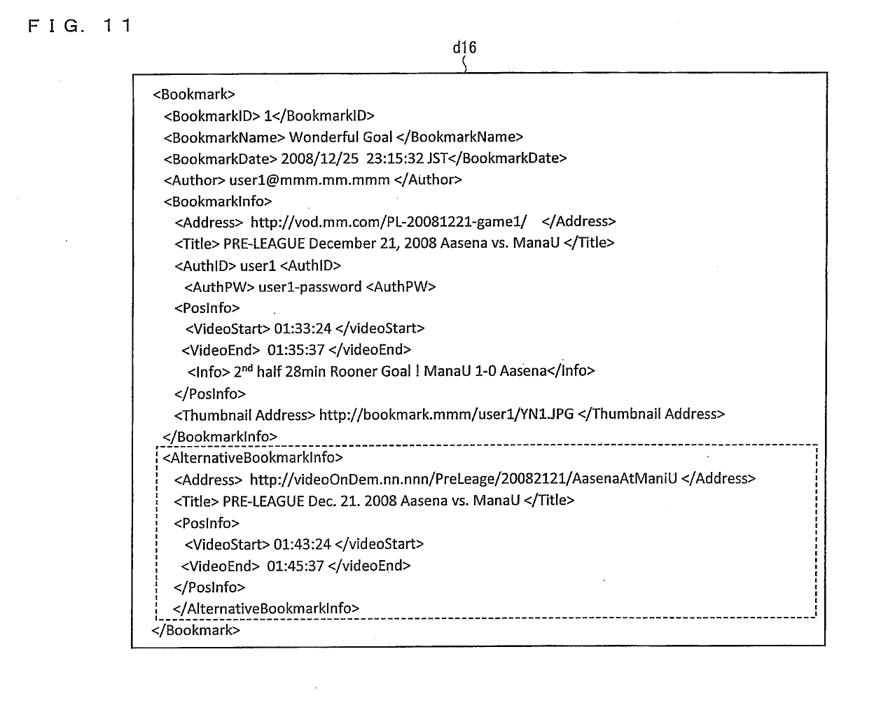

FIG. 11 is a drawing showing a specific example of the updated bookmark d16 obtained by updating the bookmark d5 in accordance with the update proposal bookmark d15.

That is, the updated bookmark d16 shown in FIG. 11 is generated in such a manner that the user A who has generated the original bookmark approves the <ProposedBookmarkInfo> component shown in FIG. 10 and then formally adds the <ProposedBookmarkInfo> component to the original bookmark d5 via the mobile phone 3.

In the updated bookmark d16 shown in FIG. 11, the <ProposedBookmarkInfo> component is rewritten as <AlternativeBookmarkInfo> component so as to be distinguishable from the original <BookmarkInfo> component. By changing the tag name and registering the tag whose name is changed, it is possible for the user-side television 2 to distinguish the bookmark generated by the creator from the bookmark generated by a user other than the creator. This can serve as exemption for the user A who has generated the original bookmark.

That is, there is a case where the user A who has generated the original bookmark approves addition of the <ProposedBookmarkInfo> component to the original bookmark but cannot determine whether the newly bookmarked content is appropriate or not. That is, the user A is not responsible for the content of the <ProposedBookmarkInfo> component. Accordingly, the <ProposedBookmarkInfo> component is rewritten as <AlternativeBookmarkInfo> component so as to clearly inform a user of the bookmark that the content of the <AlternativeBookmarkInfo> component is not generated by the creator, and that the creator is not responsible for any problem which might be caused by use of the bookmark. On the other hand, the user can understand that the <AlternativeBookmarkInfo> component is not assured by the creator and so can be careful in use of the <AlternativeBookmarkInfo> component.

As described above, in the bookmark sharing system 100 of the present invention, to the initially generated bookmark are added bookmarks of alternative contents one after another so that the bookmark is developed. In a case of using a bookmark from which a large number of bookmarks of alternative contents hang down, the user-side television 2 tries all addresses included in the bookmark, and if the user-side television 2 determines that all the addresses cannot be used, the user-side television 2 may move to an operation of searching a new alternative content.

It should be noted that the data format of the bookmark is not limited to the aforementioned XML format. The bookmark may be in any format as long as the format allows devices using the bookmark to interpret the bookmark as a structure consisting of a plurality of components.

### [Bookmark Use Sequence]

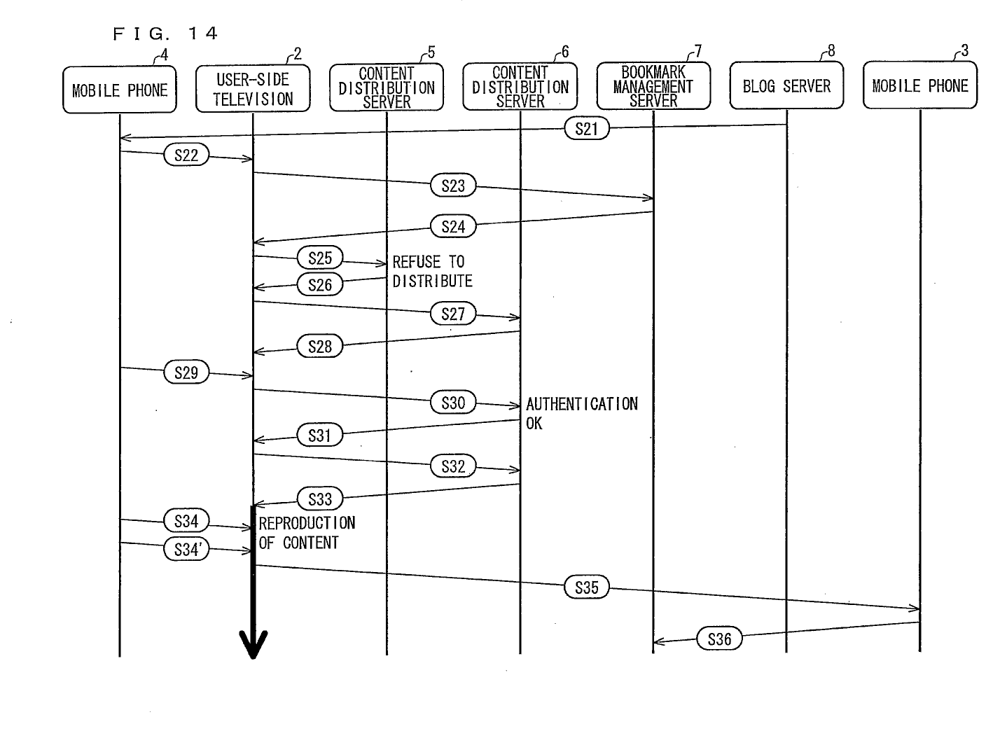

FIG. 14 is a sequence drawing showing a flow of processes of individual devices when a bookmark uploaded to the bookmark management server 7 is used in the bookmark sharing system 100. In an explanation with reference to FIG. 14, it is assumed that the user B views the blog of the user A via the mobile phone 4, downloads a bookmark URL of a link destination attached to the blog to the mobile phone 4, transmits via infrared the bookmark URL and a thumbnail image to the user-side television 2, and the user-side television 2 uses a bookmark retrieved from the bookmark management server 7 according to the bookmark URL. Then, it is assumed that the user-side television 2 tries to reproduce a content corresponding to the bookmark, but the user-side television 2 cannot retrieve the content from the content distribution server 5, and so retrieves alternative contents from the content distribution server 6 using feature information, and the user B starts to view the alternative content which the user B designates via the mobile phone 4, and the user B further designates an alternative bookmark starting/ending position via the mobile phone 4. Further, in the example shown in FIG. 14, it is assumed that the user B requests the creator of the original bookmark to update the bookmark by adding a bookmark referencing the alternative content found by the user B, so that the original bookmark is updated. Here, it is assumed that the user B can remotely control the user-side television 2 by using the mobile phone 4 as a remote controller.

Initially, it is assumed that the user B accesses the blog server 8 via the mobile phone 4, views a blog showing a video image which the user A recommends, and finds an interesting article. The user B operates the mobile phone 4 and retrieves, from the blog server 8 via the Internet, a thumbnail image which is attached to the article and in which a bookmark URL is embedded (S21). Then, the mobile phone 4 transmits the retrieved thumbnail image to the user-side television 2 via infrared (S22).

The user-side television 2 extracts the bookmark URL embedded in the thumbnail image, and accesses the bookmark management server 7 by using the bookmark URL (S23). Then, the user-side television 2 downloads the bookmark indicated by the bookmark URL from the bookmark management server 7 (S24).

Subsequently, the user-side television 2 tries to retrieve a content from the content distribution server 5 by using a content retrieval address included in the downloaded bookmark (S25). However, the user-side television 2 receives from the content distribution server 5 a notification of refusal to provide the content (S26) because the user-side television 2 does not contract with the content distribution server 5 to retrieve contents or for other reason. Consequently, the user-side television 2 cannot retrieve the desired content referenced by the bookmark even when the user-side television 2 uses the bookmark.

Accordingly, the user-side television 2 searches, using the feature information included in the previously downloaded bookmark, for an alternative content similar to the content which the user-side television 2 could not retrieve. Here, the user-side television 2 searches the content distribution server 6 with which the user B contracts for an alternative content (S27).

Then, the user-side television 2 receives the result of search from the content distribution server 6, generates an alternative content list, and causes the display section 53 to display the alternative content list so that the alternative content list is presented to the user B (S28).

The user B designates, via the mobile phone 4, an alternative content from the alternative content list displayed by the user-side television 2. At that time, the mobile phone 4 transmits a content selection signal indicative of the alternative content selected by the user B to the user-side television 2 via infrared (S29). A method for designating an alternative content from the alternative content list is no limited to designation by the user B, and may be such that the user-side television 2 itself designates the most suitable alternative content based on feature information etc.

The user-side television 2 receives the content selection signal and sends an alternative content view request (IPTV view authentication request) to the content distribution server 6 in accordance with the content selection signal (S30). The content distribution server 6 examines view authentication information from the user-side television 2, and if the view authentication information matches authentication information in the content distribution server 6 (authentication OK), the content distribution server 6 transmits information such as an alternative content retrieval address of the requested alternative content to the user-side television 2 (S31). The user-side television 2 accesses the content distribution server 6 by using information such as the received alternative content retrieval address, and requests the content distribution server 6 to start to stream the desired alternative content (S32). In response to the request, the content distribution server 6 starts to stream the designated alternative content (S33). When reproducing an alternative content, the user-side television 2 may further designate, based on feature information, an alternative reproduction position of an alternative content including a video image similar to that of the content referenced by the original bookmark.

Next, while the user-side television 2 reproduces the alternative content, the user B designates via the mobile phone 4 a reproduction position of the alternative content which position corresponds to a reproduction position of the content referenced by the original bookmark. At that time, the mobile phone 4 transmits a proposed bookmark starting position signal (S34) and a proposed bookmark ending position signal (S34′) to the user-side television 2 via infrared. Alternatively, in a case of reproducing an alternative content by designating a reproduction position of the alternative content, the user B may designate only one timing (S34 only) and transmits the designated timing as a proposed bookmark update instruction signal to the user-side television 2.

In accordance with the proposed bookmark starting position signal and the proposed bookmark ending position signal, the user-side television 2 generates an update proposing bookmark which references a reproduction position (reproduction zone) of the alternative content designated by the user B. The user-side television 2 transmits the generated update proposing bookmark to the mobile phone 3 of the user A who is the creator of the original bookmark (S35).

The user A examines the update proposing bookmark thus transmitted, and if the user A wants to accept the proposal and update the original bookmark, the user A transmits an updated bookmark based on the proposal to the bookmark management server 7 so as to update the original bookmark (S36).

As described above, even when the content referenced by the bookmark is not available, it is possible to search for an alternative content using feature information. Besides, when such an alternative content is found, it is possible to add a bookmark referencing the alternative content to the original bookmark so that the added bookmark can be also used.

### [Flow of Bookmark Use Process]

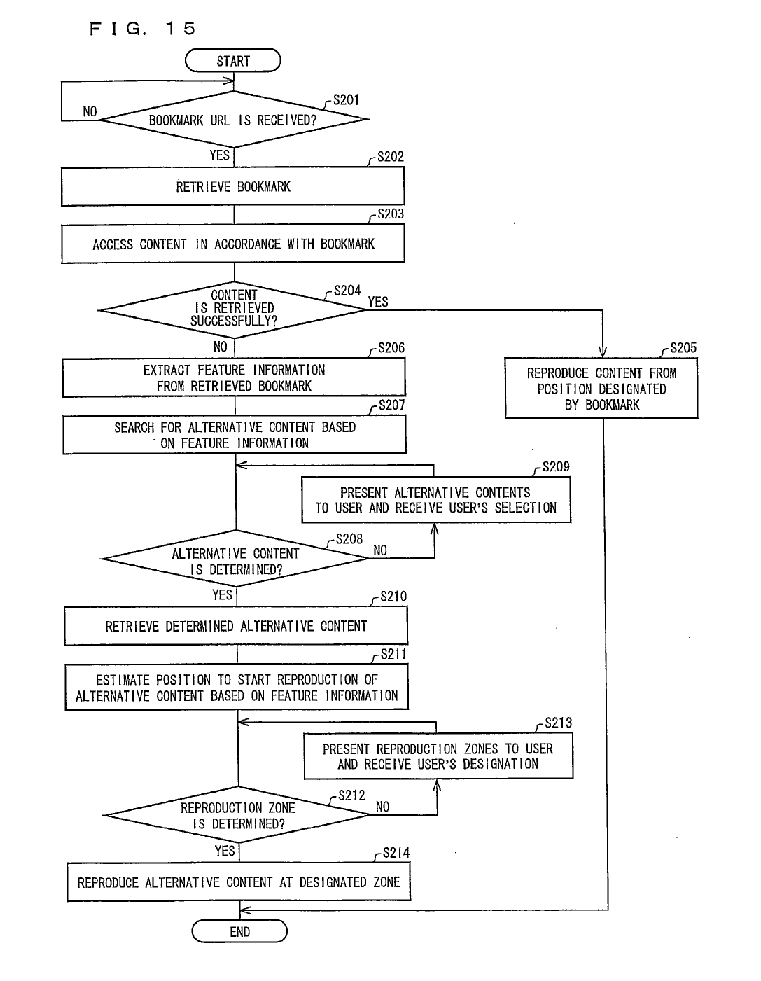

FIG. 15 is a flowchart showing a flow of the bookmark use process shown in FIG. 14 which is seen in terms of the user-side television 2.

Initially, the bookmark selecting section 60 of the user-side television 2 waits for, via the infrared communication section 51, transmission of a thumbnail image including a bookmark URL from the mobile phone 4 (S201). When the bookmark selecting section receives the thumbnail image (YES in S201), the bookmark selecting section 60 extracts the bookmark URL from the thumbnail image, and outputs the bookmark URL to the bookmark retrieval section 61.

Using the bookmark URL, the bookmark retrieval section 61 retrieves a bookmark from the bookmark management server 7 (S202). Using a content retrieval address and authentication information which are included in the bookmark retrieved by the bookmark retrieval section 61, the content retrieval section 62 requests the content distribution server 5 to distribute the content referenced by the bookmark (S203).

In a case where the content retrieval section 62 can retrieve the content referenced by the bookmark from the content distribution server 5, that is, in a case where authentication is made successfully (YES in S204), the content output section 63 outputs, to the display section 53 and the audio output section 54, data of the content which data starts from a position designated by reproduction position information included in the bookmark, so that the data is reproduced (S205).

On the other hand, in a case where the content retrieval section 62 cannot retrieve the content referenced by the bookmark from the content distribution server 5 (NO in S204), the feature information extracting section 64 extracts feature information included in the bookmark retrieved by the bookmark retrieval section 61 (S206).

Subsequently, using the feature information extracted by the feature information extracting section 64 as a search query, the alternative content search section 65 searches content sources such as the content distribution server 6 for an alternative content (S207). When searching for a content, the alternative content search section 65 mainly uses feature information on the whole content, but may also use feature information on a part (frame) of the content as well. The alternative content search section 65 generates the list of candidates of alternative contents based on the result of search transmitted from the content sources.

In a case where there are a plurality of candidates of alternative contents to be reproduced which cannot be narrowed down to one (NO in S208), the alternative content search section 65 causes the display section 53 to display an alternative content list. In response to the user's operation, the mobile phone 4 selects one alternative content from the candidates of the alternative content list displayed by the user-side television 2. At that time, the mobile phone 4 transmits via infrared a content selection signal indicative of the alternative content selected by the user B. The selection reception section 67 receives, via the infrared communication section 51, the content selection signal from the mobile phone 4, and designates the alternative content (S209 and then YES in S208).

On the other hand, in a case where there is only one candidate of an alternative content, or in a case where the alternative content search section 65 determines the most suitable alternative content from the candidates of alternative contents (YES in S208), the alternative content search section 65 outputs information on the determined alternative content to the content retrieval section 62.

The content retrieval section 62 retrieves the alternative content determined in S208 from the content distribution sever 6 for example (S210). The content retrieval section 62 may cause the retrieved alternative content to be stored in the content storage section 81 and cause the information used in retrieving the alternative content to be stored in the content retrieval information storage section 84.

Subsequently, in accordance with the feature information extracted by the feature information extracting section 64, the reproduction position estimating section 66 estimates which position in the retrieved alternative content is a position to be reproduced that corresponds to the bookmark (S211). When estimating the reproduction position, the reproduction position estimating section 66 mainly uses feature information on a part (frame) of the content, although the reproduction position estimating section 66 may also use feature information on the whole content as well. By using a large number of feature information in combination with one another as above, it is possible to improve accuracy in retrieving an alternative bookmark more similar to the original bookmark. The reproduction position estimating section 66 may causes candidates of reproduction positions (reproduction zones) to be stored in the reproduction position information storage section 83 in such a manner that the candidates are associated with the alternative content in accordance with the result of the estimation.

In a case where there are a plurality of candidates of reproduction positions (reproduction zones) which cannot be narrowed down to one (NO in S212), the reproduction position estimating section 66 outputs the candidates of reproduction zones to the display section 53 so that the user B can select one of the candidates (S213). The user B selects via the mobile phone 4 one of the candidates displayed by the user-side television 2. The selection reception section 67 receives via the infrared communication section 51 a reproduction position selection signal from the mobile phone 4 and determines the reproduction zone of the alternative content. The selection reception section 67 outputs reproduction position information (reproduction zone) of the determined alternative content to the content output section 63.

On the other hand, in a case where there is only one candidate of a reproduction position, or the reproduction position estimating section 66 determines the most suitable reproduction position of the alternative content from the candidates of reproduction positions (YES in S208), the reproduction position estimating section 66 outputs information on the determined reproduction position of the alternative content to the content output section 63.

The content output section 63 outputs, to the display section 53 and the audio output section 54, data of the alternative content which data starts from the designated reproduction position (S214).

The present invention is not limited to the above embodiments, and may be modified within the scope of claims. That is, an embodiment retrieved by combining technical means appropriately modified within the scope of claims is also encompassed in the technical scope of the present invention.

For example, in the above embodiment, remote control of the creator-side television 1 and the user-side television 2 is made by using the mobile phones 3 and 4 as remote controllers. However, the present invention is not limited to this. Instruction to generate a bookmark may be made using a conventional television remote controller. However, it should be noted that transmission/reception of information such as a bookmark between a communication terminal device such as a mobile phone and a television in close-distance wireless communications makes it unnecessary to connect the creator-side television 1 and the user-side television 2 with a network. That is, even if the user-side television 2 is unable to connect with the network, it is possible to cause the user-side television 2 to reproduce an alternative content by causing the mobile phone 4 to supply a bookmark and causing the user-side television 2 to search for an alternative content available.

In the above embodiment, in order to publish a bookmark uploaded to the bookmark management server 7, a bookmark URL is supplied to the mobile phone 3, and the mobile phone 3 causes the blog server 8 to publish the bookmark URL. Alternatively, the bookmark management server 7 may have a function of publishing an uploaded bookmark to unspecified number of users. That is, it is not always necessary for the bookmark sharing system of the present invention to include the blog server 8.

In the above embodiment, an explanation was made to an example in which the feature information generating section 24 of the creator-side television 1 is configured to extract text information from video data or audio data constituting the main body of the content or meta information on the content (see FIG. 4). However, the configuration of the feature information generating section 24 is not limited to this. For example, in a case where content-related information including information associated with a content is supplied in sync with the content, the feature information generating section 24 can extract feature information not only from the content itself but also from content-related information supplied in sync with the content. Examples of the content-related information include sub-audio broadcasting, text broadcasting, and various related information retrieved from a server via the Internet.

The content-related information is not required to be supplied in sync with the content. The content-related information may be retrieved with timing different from that in retrieval and reproduction of the content provided that the content-related information includes information which enables sync with a reproduction position of the content. For example, the creator-side television 1 may be configured such that the creator-side television 1 retrieves the content-related information in advance from a content-related information provider (e.g. content distribution servers 5 and 6) and stores the content-related information, and when generating a bookmark, the creator-side television 1 searches the stored content-related information for content-related information corresponding to a content for which the creator-side television 1 intends to generate a bookmark, and extracts feature information. Further, the creator-side television 1 may be configured such that when generating a bookmark, the creator-side television 1 searches the Internet for content-related information corresponding to a content for which the creator-side television 1 intends to generate a bookmark, and when finding corresponding content-related information, the creator-side television 1 downloads and uses the corresponding content-related information. Alternatively, the creator-side television 1 may be configured such that the creator-side television 1 transmits retrieval address information (URL) of the content-related information to the bookmark management server 7 which the creator-side television 1 requests to generate a bookmark, and the bookmark management server 7 retrieves the content-related information in accordance with the retrieval address information and uses the content-related information in generating a bookmark.

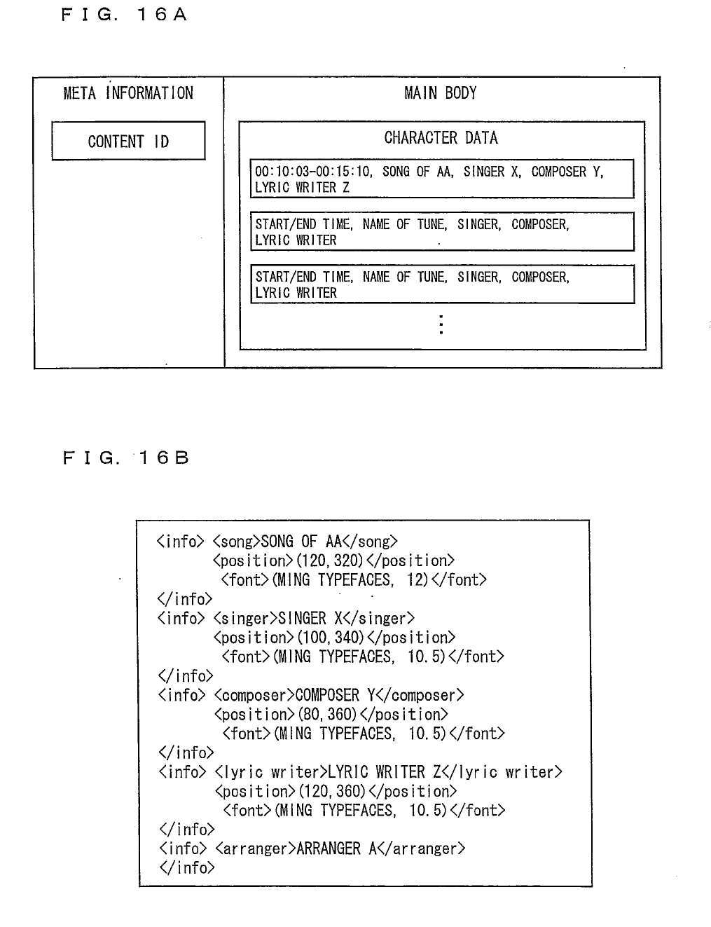

FIG. 16A shows an example of a data structure of content-related information. An explanation as to the content-related information shown in FIG. 16A will be made in detail later. As shown in FIG. 16A, a content ID is assigned as meta information to the content-related information just like the content ID is assigned to the content, so that it is possible to determine which content the content-related information is associated with. Further, the main body of the content-related information may include information for synchronizing with the content (e.g. reproduction time). In this case, even when the creator-side television 1 retrieves the content-related information separately from the content, the creator-side television 1 can process the content-related information in sync with the content. Consequently, with timing of receiving a bookmark registration signal d4 from the mobile phone 3, the feature information generating section 24 of the creator-side television 1 can extract feature information from content-related information on the content to be bookmarked. Specifically, the feature information generating section 24 extracts text information from captions which are content-related information on a movie content, and from superimposed texts such as names of tunes, singers, composers, and lyric writers which are content-related information on a musical program content. The data form of the content-related information may be a text or binary data (binary data of audio, image, compressed data etc.). In a case where the content-related information is outputted in sync with the content, the content-related information is, similarly with the main body of the content, associated with timing with which the bookmark registration signal d4 is inputted to the creator-side television 1 and registered as a part of a bookmark.

### [Modification Examples of Bookmark Sharing System]

### (1) View Missed Program

With the bookmark sharing system 100 of the present invention, when a user of the user-side television 2 wants to view a content having been already broadcasted (distributed) at a certain date, the user-side television 2 can retrieve an alternative content similar to the content by using a bookmark of the present invention.

For example, assume that the user B shown in FIG. 2 views the blog of other user A (d8) and finds that the user B has missed a program (content) which the user B has intended to view but has been already digitally broadcasted.

The user B cannot view via the user-side television 2 the bookmarked program itself which was uploaded by the user A to the blog. The reason why the user B cannot view the program is, for example, such that the program was broadcasted only on that date, or the program was distributed from a broadcasting station whose broadcasting cannot be received in the area where the user B lives.

Therefore, the user-side television 2 of the user B accesses a server of an IP television service with which the user B contracts, where contents are stored and managed (e.g. a server for distributing contents, such as the content distribution server 6). Using feature information included in the bookmark of the user A as a search query, the use-side television 2 can detect an alternative program similar to the bookmarked original program from programs to be broadcasted in the future from the IP television service.

When the user-side television 2 finds the alternative program, the user-side television 2 retrieves, from the server, information on the alternative program (e.g. date of broadcast, channel, content identification information (program number) for viewing content by VoD). Using the information thus retrieved, the user-side television 2 can instantly retrieve a program by VoD, reproduce the program, or book reproduction/record. Thus, the user B can view, using a bookmark, the alternative program similar to a program the user B has found missed.

### (2) Recommendation for Viewing Complete Programs

In the above embodiment, an explanation was made as to a configuration in which the user-side television 2 can detect an alternative content similar to the original content by using feature information included in the bookmark of the present invention.

However, the present invention is not limited to this. Using the bookmark of the present invention (feature information included in the bookmark), the user-side television 2 can detect not only an alternative content but also a related content which is associated with the bookmarked content.

For example, assume that the user-side television 2 of the user B retrieves the bookmark which was generated by the user A and which references the last episode (eleventh episode) of a serial drama. Further, assume that, regardless of whether the last episode referenced by the bookmark is retrievable or not, based on feature information of the serial drama, the user-side television 2 can identify a previous content (i.e. tenth episode) related to the serial drama and determine whether the previous content has been reproduced or not by the user-side television 2.

In a case where there is no history that the previous content has been viewed, the user-side television 2 may detect the tenth content which is a related content, based on feature information included in the bookmark referencing the eleventh content, and ask the user B whether the user B wants to view the tenth content or not.

With the arrangement, the user-side television 2 can detect a related content related to the original content by using the feature information included in the bookmark, and recommend, to the user B, an unviewed content out of a plurality of related (serial) contents. Consequently, the user B can avoid missing a part of a plurality of related contents, so that the user B enjoys more user-friendliness.

Determination on whether the previous content has been viewed or not based on the view history may be made by, instead of the user-side television 2, the content distribution server 6 which distributes contents to the user-side television 2. In this case, the content distribution server 6 searches for a requested content in accordance with feature information (search query) included in the bookmark supplied from the user-side television 2, and when the requested content is related to other related content, the content distribution server 6 may propose distribution of the related content to the user-side television 2.

### (3) Search for Similar Content

Using feature information included in the bookmark of the present invention as a search parameter, the user-side television 2 may search for a content similar to the content reproduced with use of the bookmark.

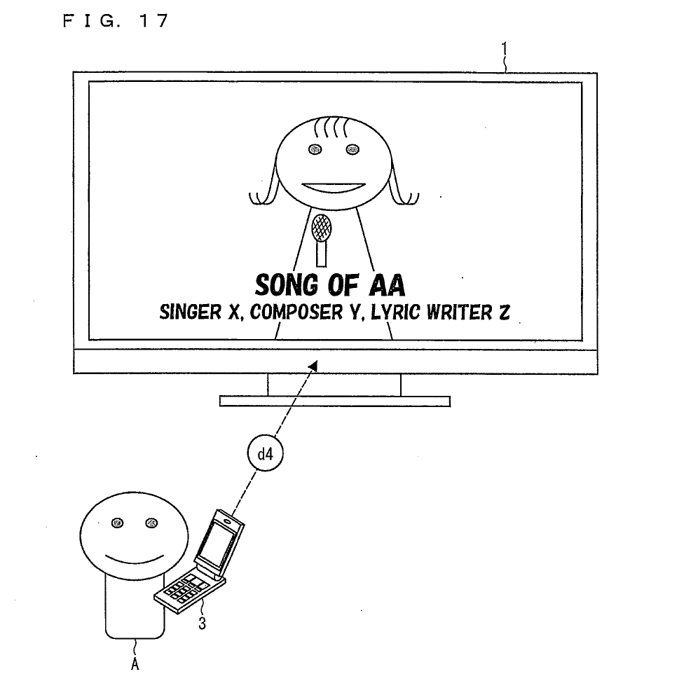

FIG. 16A is a drawing showing a specific example of content-related information on a musical program content reproduced by the creator-side television 1. FIG. 17 is a drawing showing a specific example of a display screen of the creator-side television 1 and how a user viewing the content registers a bookmark.

The content retrieval section 62 of the creator-side television 1 has retrieved the musical program content shown in FIG. 4 and content-related information shown in FIG. 16A. The content and the content-related information are linkable by a content ID included in meta information.

Further, in the present embodiment, as shown in FIG. 16A, the content-related information includes information associated with a content in such a manner that the information is associated with reproduction time information for reproducing the information in sync with the musical program content. In the present embodiment, the content is a musical program content, and so the content-related information includes information on a tune which will be singed during the reproduction time. Specifically, names of a tune, a singer, a composer, and a lyric writer are included in the content in this order.

In sync with output of the musical program content (FIG. 4), the content output section 22 outputs to the display section 13 content-related information shown in FIG. 16A in such a manner that the content-related information is overlapped with the musical program content (FIG. 4). Consequently, as shown in FIG. 17, the display section 13 of the creator-side television 1 displays the title, the singer, the composer, and the lyric writer of the currently sung tune in such a manner that these data are overlapped with the musical program content.

In the examples shown in FIGS. 16A and 17 in accordance with the present embodiment, information included in content-related information associated with a reproduction position (time in content) of the content is outputted in such a manner as to be overlapped with the content. The creator-side television 1 etc. outputs the content-related information in such a manner that the content-related information is fixed to a predetermined position or that if the content-related information is a one to be outputted in sync with the content, the content-related information is outputted according to layout information for overlapping. The layout information may be included in the content-related information or may be retrieved as needed by referring to a retrieval address included in the content-related information.

FIG. 16B is a drawing showing an example of layout information for specifying an output layout for content-related information. In the example shown in FIG. 16B, information items included in structured layout information are discernable by predetermined tags. The name of a tune and the name of a singer are discernable by tags such as <song> and <singer>, respectively. Further, with respect to each kind of information to be outputted in an overlapped manner, information for specifying a layout, i.e. an output position <position> (x, y) on a screen and an output setting <font> (font, size) are determined. In this example, the output position is shown in absolute coordinates, but may be shown in relative coordinates. In a case where the layout information is generated in the XML format, it is possible to easily add various data attributes. For example, FIG. 16B shows an example in which the output position <position> is not described for an arranger A so as to specify that information on the arranger A is not to be outputted in such a manner as to be overlapped with the content. Needless to say, this is merely an example and the XML format and the meanings of tags with respect to a layout may be determined freely for each service. Tags may be defined freely and a data format other than XML may be used, provided that it is possible to specify whether content-related information is to be displayed or not and to specify attribute information when displaying the content-related information.

Assume that while reproducing the content shown in FIG. 17, the mobile phone 3 of the user A transmits the bookmark registration signal d4 and the creator-side television 1 receives the signal d4 as with the previously shown examples. At that time, the feature information generating section 24 extracts feature information from the content shown in FIG. 4 and/or the content-related information shown in FIG. 17. The bookmark generating section 25 generates a bookmark including the feature information. In order to request the bookmark management server 7 to register the bookmark, the bookmark transmitting section 26 transmits the bookmark and the registration request message d5 to the bookmark management server 7. The bookmark registration signal d4 may be made by merely assigning one of unused codes for infrared remote control signals to bookmark registration in an IPTV device such as the creator-side television 1 and the user-side television 2. This enables the IPTV device, when receiving the assigned signal, to start a bookmark generating process mounted in advance on the IPTV device.

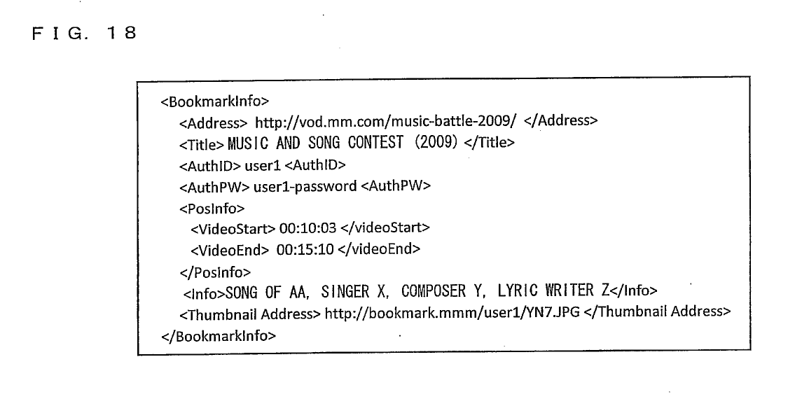

Consequently, the bookmark shown in FIG. 18 is registered in the bookmark management server 7.

FIG. 18 is a drawing showing a specific example of a bookmark registered in the bookmark management server 7. FIG. 18 shows only a description between tags <BookmarkInfo>. Other information included in the bookmark is the same as that in the above embodiment (FIG. 6) and therefore is not shown in FIG. 18.

In the example shown in FIG. 18, between <Info> tags of the bookmark, there is described feature information extracted by the feature information generating section 24 from the content-related information shown in FIG. 17, i.e. song of AA (title of tune), singer X, composer Y, and lyric writer Z.

In the user-side television 2 using the bookmark, feature information between the <Info> tags is information on the title of tune, singer, composer, and lyric writer in the order of description.

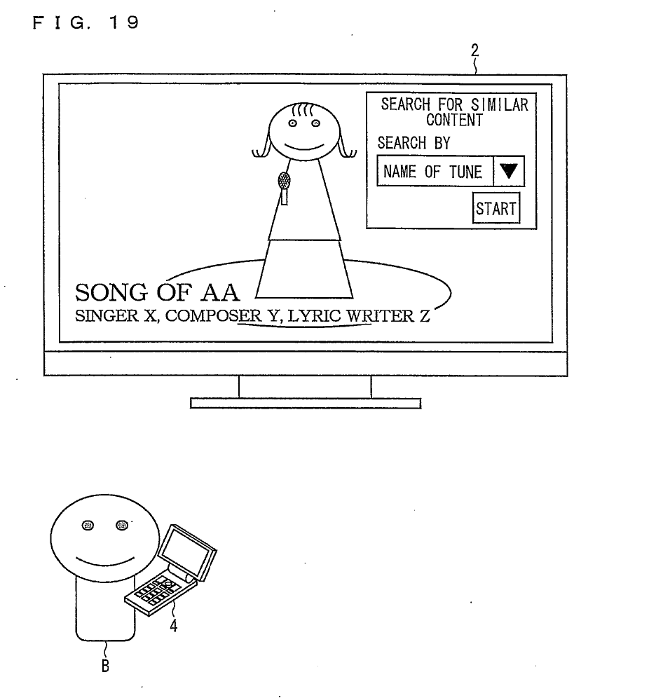

Using the bookmark, the user-side television 2 can resume-reproduce the musical program content starting at the beginning of the song of the singer X. Of course, there is a possibility that the user-side television 2 of the user B cannot reproduce the musical program content since the bookmark was made by the user A. In such a case, according to the procedure already explained in the above embodiment, the user-side television 2 searches for an alternative content by using the feature information included in the bookmark shown in FIG. 18, and reproduces an alternative content of the musical program content viewed by the user A, as shown in FIG. 19. FIG. 19 is a drawing showing a specific example of a display screen of the user-side television 2 which displays an alternative content by using the bookmark shown in FIG. 18. In a case where content-related information is in sync with the alternative content, the content output section 63 may display superimposed texts of the alternative content in an overlapping manner.

Further, in the present embodiment, using feature information included in the used bookmark (or content-related information for the currently viewed content), it is possible to search for similar contents and display the list of similar contents. The content output section 63 of the user-side television 2 displays not only the content but also a GUI (Graphical User Interface) for searching for similar contents. For example, in the example shown in FIG. 19, the user B operates the mobile phone 4 and presses a “START” button so as to instruct the user-side television 2 to search for similar contents viewable whose title of tune correspond to the currently viewed content. The alternative content search section 65 extracts the title of tune from content-related information of the content viewed when instruction to search is made via the GUI or from feature information included in the bookmark used for reproduction of the currently viewed content, and outputs to the display section 53 the list of contents with content-related information including the title of tune (here, “song of AA”) (alternatively, the list of bookmarks including the title of tune).

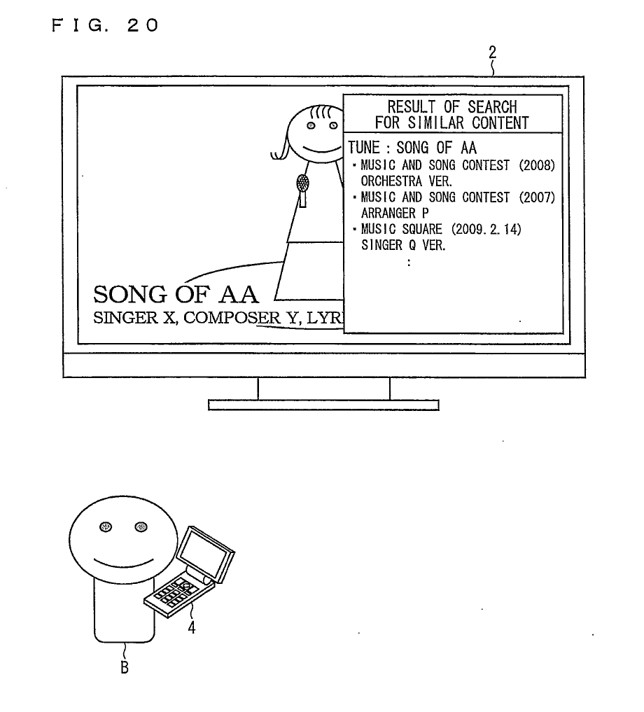

FIG. 20 is a drawing showing an example of a display screen of the display section 53 which displays the result of searching by the alternative content search section 65 for similar contents. The content list shown in FIG. 20 displays the list of contents including scenes where “the song of AA” was sang regardless of the singer, composer etc.

With the arrangement, it is possible to easily search for a similar content which is viewable by the user-side television 2 and in which the same song is sang, in accordance with the name of the currently heard song. For example, if a user takes a liking for the currently heard song, by searching for similar contents with the title of tune as a search key, it is possible to easily search for all the contents related to the song, widely including the original and cover versions. Similarly, using other content-related information such as a singer and a composer as a search key, it is possible to search for similar contents viewable and hearable.

### (4) Bookmark Management Server

In the above embodiments, an explanation was made as to a configuration of the bookmark sharing system 100 in which the creator-side television 1 includes the feature information generating section 24 and the bookmark generating section 25. However, the bookmark sharing system 100 of the present invention is not limited to this. For example, the bookmark sharing system 100 may be configured such that the bookmark management server 7 includes the feature information generating section 24 and the bookmark generating section 25 and the bookmark management server 7 generates a bookmark in response to a request from the creator-side television 1 and feedbacks the bookmark to the creator-side television 1.

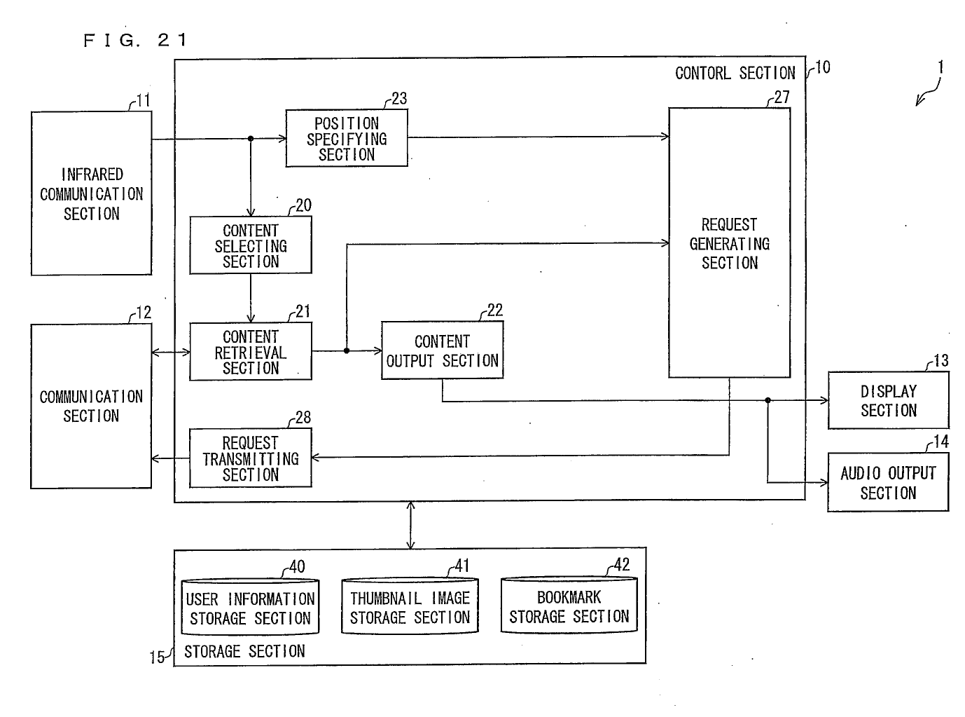

FIG. 21 is a block diagram showing a configuration of a main part of the creator-side television 1 in the case where the bookmark management server 7 generates a bookmark. The configuration of the creator-side television 1 shown in FIG. 21 is different from the configuration of the creator-side television 1 shown in FIG. 2 in that the creator-side television 1 includes a request generating section 27 instead of the bookmark generating section 25 and includes a request transmitting section 28 instead of the bookmark transmitting section 26.

When the creator-side television 1 receives the bookmark registration signal d4 from the mobile phone 3, the request generating section 27 retrieves from the content retrieval section 21 a content ID of a content reproduced by the content output section 22 with timing when the bookmark signal d4 is received. Then, the request generating section 27 identifies a reproduction position in the currently reproduced content which position corresponds to timing specified by the position specifying section 23. The request generating section 27 generates a bookmark generating request including the identified content ID and the identified reproduction position.

The request transmitting section 28 transmits the bookmark generating request generated by the request generating section 27 to the bookmark management server 7.

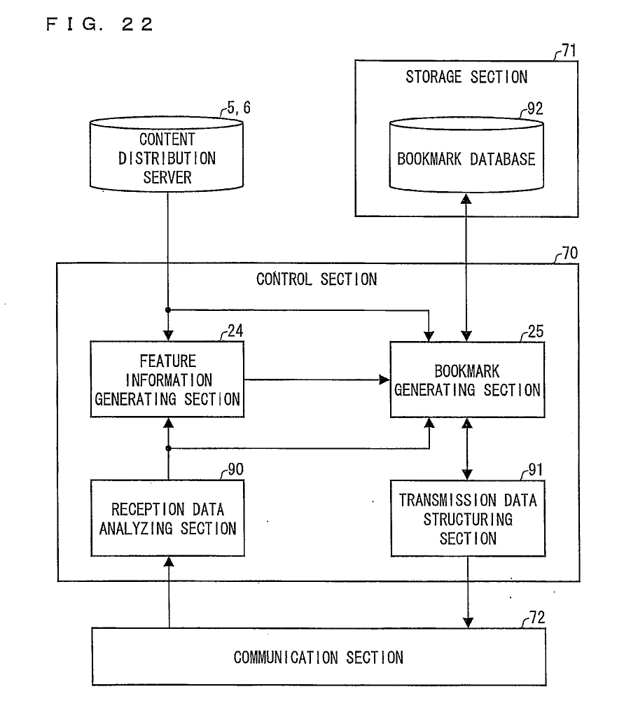

FIG. 22 is a block diagram showing a configuration of a main part of the bookmark management server 7 which generates a bookmark.

As shown in FIG. 22, the bookmark management server 7 at least includes a control section 70, a storage section 71, and a communication section 72.

The storage section 71 stores bookmarks managed by the bookmark management server 7. In the present example, the bookmark management server 7 has a bookmark database 92 which is a database of bookmarks generated by the bookmark management server 7, and causes the bookmark database 92 to be stored in the storage section 71.

The communication section 72 communicates with external devices via a communication network. For example, the communication section 72 communicates with the creator-side television 1, the user-side television 2, the mobile phone 3, the mobile phone 4, the content distribution server 5, and the content distribution server 6 via the Internet.

The control section 70 centrally controls sections of the bookmark management server 7. The control section 70 includes, as functional blocks, the feature information generating section 24, the bookmark generating section 25, a reception data analyzing section 90, and a transmission data structuring section 91.

The reception data analyzing section 90 receives and analyzes a bookmark generating request from the creator-side television 1.

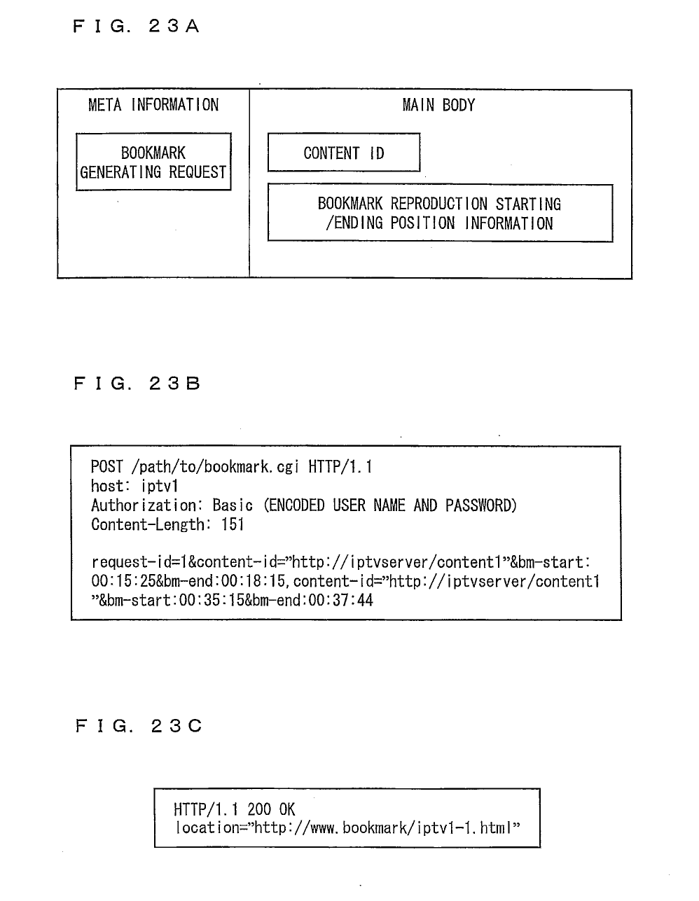

FIG. 23A is a drawing schematically showing a data structure of a bookmark generating request generated by the request generating section 27 of the creator-side television 1. As shown in FIG. 23A, the bookmark generating request at least includes a content ID and information on a reproduction position of a content. The reception data analyzing section 90 extracts the content ID and the reproduction position from the request and informs sections of the feature information generating section 24 and the bookmark generating section 25 of the content ID and the reproduction position.

The bookmark generating request may be realized by an HTTP POST method using an HTTP protocol for example. Needless to say, the protocol is not particularly limited as long as it enables transmission of a request from a client to a server. FIG. 23B shows a specific example of a bookmark generating request generated according to the HTTP POST method. In the example shown in FIG. 23B, parameters are “content-id” indicative of a content ID, a URL for specifying a content, and “bm-start” and “bm-end” which define information on a reproduction position on the content (reproduction starting position and reproduction ending position, respectively). By describing a plurality of information side by side in the bookmark generating request as in this example, it is possible to request to generate a bookmark in which a plurality of information are registered. As described above, with reference to the example shown in FIG. 23B, an explanation was made as to appropriately designing a data structure of a bookmark generating request in accordance with feature information and a format of a bookmark. However, the bookmark generating request of the present invention is not limited to the example shown in FIG. 23B.

When the bookmark management server 7 successfully generates a bookmark, the bookmark management server 7 generates a response including address information (URL) of the generated bookmark, as in the example shown in FIG. 23C. The bookmark management server 7 transmits the generated response to the creator-side television 1 etc. which has requested the bookmark management server 7 to generate a bookmark. In the example shown in FIG. 23C, the bookmark management server 7 generates a file name of a bookmark (“iptv1-1.html”) based on “host” and “request-id” included in the request shown in FIG. 23B.

Basic authentication may be made in order to provide a bookmark service for each user. In this case, a sender of a request (e.g. creator-side television 1) transmits a bookmark generating request without authentication information to the bookmark management server 7 and then the bookmark management server 7 sends back an error response for requesting authentication to the creator-side television 1. Then, the creator-side television 1 retransmits the HTTP request in which user information and a password are added to authentication header (Authorization:). As described above, the request and the response in the present invention may be made by any communication means including the HTTP protocol. Accordingly, in terms of whether user authentication is to be made or not and what way the user authentication is to be made, the present invention is not limited to the above example.

The feature information generating section 24 extracts feature information from the content (FIG. 4) and/or the content-related information (FIG. 17) identified by the content ID and information on the reproduction position. The content and the content-related information may be supplied via the communication section 72 from the content distribution server 5 (or the content distribution server 6) which distributes the content.

In accordance with the content ID, the reproduction position and the feature information, the bookmark generating section 25 generates the bookmark shown in FIGS. 6, 7, 18 etc., and registers the bookmark in the bookmark database 92.

The transmission data structuring section 91 generates a response to the request received by the bookmark management server 7. The response generated by the transmission data structuring section 91 to the bookmark generating request is a bookmark URL of the registered bookmark and a registration completion notification (d6). The bookmark URL of the registered bookmark and a registration completion notification (d6) which are generated by the transmission data structuring section 91 may be transmitted to both of or one of the creator-side television 1 which is a sender of the request and the mobile phone 3 of the user.

In a case where the feature information generating section 24 is included in the creator-side television 1, the request generating section 27 may incorporate the feature information extracted by the feature information generating section 24 into the bookmark generating request and notify the bookmark management server 7 of the feature information. In this case, the bookmark management server 7 is required to include only the bookmark generating section 25, and the bookmark generating section 25 can generate a bookmark by using the feature information extracted by the reception data analyzing section 90 from the bookmark generating request.

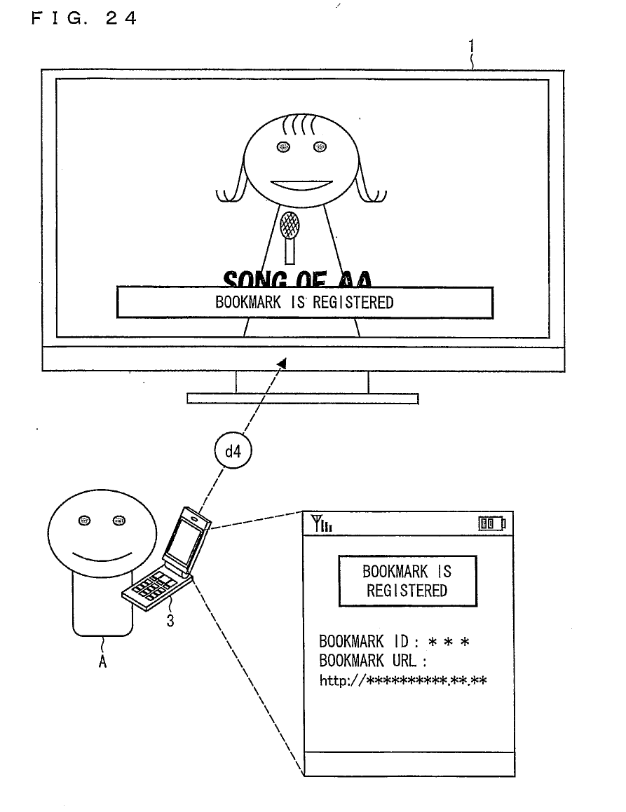

FIG. 24 is a drawing showing how a user viewing a content registers a bookmark when the bookmark management server 7 generates the bookmark, and examples of display screens displayed by display sections of the creator-side television 1 and the mobile phone 3 at that time.

When the user A who is viewing a content on the creator-side television 1 causes the mobile phone 3 to transmit the bookmark registration signal d4, the creator-side television 1 transmits a bookmark generating request to the bookmark management server 7 according to the above procedure. The bookmark generating section 25 of the bookmark management server 7 generates a bookmark in response to the request and registers the bookmark in the bookmark database 92 so as to retrieve the URL of the bookmark. The bookmark URL and the registration completion notification d6 are transmitted to the creator-side television 1 and/or the mobile phone 3.

In the example shown in FIG. 24, the creator-side television 1 having received the bookmark URL and the registration completion notification d6 displays on a message indicating that the bookmark is duly registered. It is desirable that the message is displayed in a small size for a short time in order not to prevent the user from viewing the creator-side television 1. The mobile phone 3 may display not only the message indicating that the bookmark is duly registered but also information useful in managing the bookmark. This enables the user A to carry out, via the mobile phone 3, another process using the newly generated bookmark. For example, the user A can upload the generated bookmark to the blog server 8 by a simple operation of the mobile phone 3.

In the above embodiments, the bookmark sharing system 100 is designed such that the user-side television 2 includes the feature information extracting section 64, the alternative content search section 65, and the reproduction position estimating section 66, and when the user cannot view the content referenced by the bookmark, the user-side television 2 detects an alternative content. However, the configuration of the bookmark haring system 100 is not limited to this. For example, the bookmark management server 7 may include the feature information extracting section 64, the alternative content search section 65, and the reproduction position estimating section 66 (not shown). In this case, when the bookmark management server 7 determines that a bookmarked content requested by the user-side television 2 is not viewable by the user-side television 2, the bookmark management server 7 inquires the content distribution server 6 which distributes contents viewable by the user-side television 2 of an alternative content (the transmission data structuring section 91 generates a content search request and transmits it to the content distribution server 6). The bookmark management server 7 generates the list of candidates of alternative contents based on the result of the inquiry and supplies the list to the user-side television 2.

The user-side television 2 receives the list from the bookmark management server 7 and causes the display section 53 of the user-side television 2 so that the user can select one alternative content in the list. The user selects a desired alternative content, and consequently the user can view the alternative content instead of the bookmarked content unviewable by the user.

### [Means to Solve the Problem]

The bookmark using device includes: feature information extracting means for extracting feature information indicative of a subject of a content and/or a subject at a reproduction position of the content from a bookmark including at least (i) a content retrieval address used in retrieving the content, (ii) reproduction position information indicative of the reproduction position of the content, and (iii) the feature information; and alternative content detecting means for detecting, in accordance with the feature information extracted by the feature information extracting means, an alternative content whose subject is similar to or corresponds to the subject of the whole content or to a subject at the reproduction position of the content from one or a plurality of content sources for supplying a content usable by the bookmark using device.

With the arrangement, the feature information extracting means extracts feature information from a bookmark including at least (i) a content retrieval address used in retrieving a content, (ii) reproduction position information, and (iii) feature information, and the alternative content detecting means detects, in accordance with the extracted feature information, an alternative content whose subject is similar to or corresponds to the content.

Consequently, the bookmark using device can find an alternative content which is different from the original content retrievable by using the content retrieval address and which has a subject similar to or corresponding to the subject of the original content. The alternative content thus found is supplied from a content source usable by the bookmark using device.

Thus, it is possible to realize a bookmark using device which enables a user to view an alternative content which is different from a content referenced by the bookmark the user has intended to use and which has a subject similar to or corresponding to the content referenced by the bookmark.

Consequently, even if the content referenced by the bookmark the user has intended to use is unviewable for a reason such as difference in service etc., the bookmark using device with the above arrangement enables the user to view another content whose subject is similar to the content referenced by the bookmark. Accordingly, the bookmark using device of the present invention is particularly useful in a case where devices contracting with different services share one bookmark which the devices have generated in collaboration with each other.

For example, under a situation such that unspecified number of users share a bookmark referencing a content distributed via communications etc., even if a user cannot access a content bookmarked by a device of another user, the present invention enables the user to view a content whose subject is similar to that of the bookmarked content by retrieving such a similar content from other distributor etc.

It is preferable to arrange the bookmark using device so as to further include reproduction position specifying means for specifying, in accordance with the feature information, a reproduction position of the alternative content at which reproduction position a subject of the alternative content is similar to or corresponds to the subject at the reproduction position of the content.

With the arrangement, it is possible to detect, in accordance with the feature information, not only an alternative content but also an alternative reproduction position of the alternative content at which reproduction position the subject of the alternative content is similar to or corresponds to the subject at the reproduction position of the bookmarked original content.

Consequently, the user can view the alternative content more accurately reflecting the subject of the original bookmark.

It is preferable to arrange the bookmark using device so as to further include bookmark update means for generating an alternative bookmark including at least an alternative content retrieval address used in retrieving an alternative content detected by the alternative content detecting means.

It is preferable to arrange the bookmark using device so as to further include bookmark update means for generating an alternative bookmark including at least (i) an alternative content retrieval address used in retrieving an alternative content detected by the alternative content detecting means and (ii) alternative reproduction position information indicative of a reproduction position of the alternative content which reproduction position is specified by the reproduction position specifying means.

With the arrangement, it is possible to generate an alternative bookmark which more accurately reflects the subject of the original bookmark and which references the alternative content and the alternative reproduction position.

It is preferable to arrange the bookmark using device such that the bookmark update means adds the generated alternative bookmark to the bookmark as an original so that the bookmark is updated to be an updated bookmark.

With the arrangement, the updated bookmark includes both of information for accessing the original content and information for accessing the newly found alternative content. Consequently, a bookmark using device which uses the updated bookmark after the update can retrieve either of the original content or the alternative content which the bookmark using device can use.

Consequently, it is possible to improve availability of the original bookmark in order to enable more number of bookmark using devices to use the original bookmark.

It is preferable to arrange the bookmark using device such that the bookmark update means transmits the updated bookmark to a bookmark creation device having generated the bookmark as an original so as request the bookmark creation device to update the bookmark as an original.

The bookmark using device may be arranged such that

the feature information included in the bookmark includes text information indicative of the subject of the content, and the alternative content detecting means uses a character sequence in the text information as a search query so as to detect an alternative content similar to or corresponding to the content as an original.

The bookmark using device may be arranged so as to further include a content retrieval information storage section for storing authentication information necessary for accessing said one or said plurality of content sources, the alternative content detecting means accessing each of said one or said plurality of content sources by using the authentication information stored in the content retrieval information storage section.

The bookmark using device may be arranged such that the feature information included in the bookmark includes image data of the content, and the alternative content detecting means uses as a search query an image characteristic extracted from the image data so as to detect an alternative content similar to or corresponding to the content as an original.

The bookmark using device may be arranged such that

the feature information included in the bookmark includes image data at the reproduction position of the content, and the reproduction position specifying means specifies, in accordance with an image characteristic extracted from the image data, a reproduction position of the alternative content which reproduction position is similar to or corresponds to the reproduction position of the content as an original.

The bookmark creation device includes: content retrieval means for retrieving a content from a content source which supplies a content usable by the bookmark creation device; feature information generating means for generating, from the content retrieved by the content retrieval means, feature information indicative of a subject of the content; and bookmark generating means for generating a bookmark including at least (i) a content retrieval address used when the content retrieval means retrieves the content, (ii) reproduction position information indicative of a reproduction position of the content which reproduction position is specified by a user; and (iii) the feature information generated by the feature information generating means.

With the arrangement, the bookmark creation device can transmit, to the bookmark using device, a bookmark referencing the content and the reproduction position in combination with feature information indicative of the subject of the content. Accordingly, even if the bookmark using device which is the user of the bookmark cannot use the content referenced by the bookmark, the bookmark using device can estimate the subject of the bookmarked content based on the feature information. That is, the bookmark using device can use the feature information as a clue for searching for another content whose subject is similar to the bookmarked content.

The bookmark creation device may be arranged such that the feature information generating means generates feature information indicative of a subject at the reproduction position of the content which reproduction position is specified by the user.

The bookmark creation device may be arranged such that the feature information generating means continuously or periodically extracts specific text information of the content as well as the reproduction position information of the content, and generates feature information on a reproduction position at which the text information changes.

The bookmark creation device may be arranged such that the feature information generating means generates feature information based on meta information which is associated with the content and which regards the content.

The bookmark creation device may be arranged such that the feature information generating means generates feature information by extracting text information from image data of the content.

The bookmark creation device may be arranged such that the feature information generating means generates feature information by extracting text information from audio data of the content.

The bookmark creation device of the present invention may be arranged such that the feature information generating means generates feature information which is image data extracted from the content or information indicative of a location where the image data is stored.

A bookmark sharing system including the above bookmark creation device, a bookmark management server for storing and managing the bookmark generated by the bookmark creation device, and the above bookmark using device for using a bookmark retrieved from the bookmark management server is also encompassed in the scope of the present invention.

The bookmark using device and the bookmark creation device may be realized by a computer. In this case, a control program for the bookmark using device or the bookmark creation device, which causes a computer to operate as the above means so as to realize the bookmark using device or the bookmark creation device by a computer, is also encompassed in the scope of the present invention. Further, a computer-readable storage medium in which the control program is stored is also encompassed in the scope of the present invention.

### INDUSTRIAL APPLICABILITY

The bookmark creation device of the present invention and the bookmark using device of the present invention are particularly preferably applicable to a bookmark sharing system in which unspecified number of users who use contents under different environments share bookmarks of contents.

### REFERENCE SIGNS LIST

1: Creator-side television (bookmark creation device)
2: User-side television (bookmark using device)
3: Mobile phone
4: Mobile phone
5: Content distribution server
6: Content distribution server
7: Bookmark management server (bookmark creation device)
8: Blog server
10: Control section
11: Infrared communication section
12: Communication section
13: Display section
14: Audio output section
15: Storage section
20: Content selecting section
21: Content retrieval section (content retrieval means)
22: Content output section
23: Position specifying section
24: Feature information generating section (feature information generating means)
25: Bookmark generating section (bookmark generating means)
26: Bookmark transmitting section
27: Request generating section
28: Request transmitting section
40: User information storage section
41: Thumbnail image storage section
42: Bookmark storage section
50: Control section
51: Infrared communication section
52: Communication section
53: Display section
54: Audio output section
55: Storage section
60: Bookmark selecting section
61: Bookmark retrieval section
62: Content retrieval section
63: Content output section
64: Feature information extracting section (feature information extracting means)
65: Alternative content search section (alternative content detecting means)
66: Reproduction position estimating section (reproduction position specifying means)
67: Selection reception section
68: Bookmark update request section (bookmark update means)
70: Control section
71: Storage section
72: Communication section
80: Bookmark storage section
81: Content storage section
82: Alternative content list storage section
83: Reproduction position information storage section
84: Content retrieval information storage section
90: Reception data analyzing section
91: Transmission data structuring section
92: Bookmark database
100: Bookmark sharing system

1-24. (canceled)

25. A bookmark using device, comprising:
feature information extracting means for extracting a feature information indicative of a subject of a content from a bookmark including at least (i) a content retrieval address used in retrieving the content and (ii) the feature information; and
alternative content detecting means for detecting, in accordance with the feature information extracted by the feature information extracting means, an alternative content whose subject is similar to or corresponds to the subject of the content from one or a plurality of content sources for supplying a content usable by the bookmark using device.

26. The bookmark using device as set forth in claim 25, wherein
the bookmark further includes reproduction position information indicative of a reproduction position of the content, and the feature information is indicative of a subject of the content at the reproduction position indicated by the reproduction position information, and
the alternative content detecting means detects, in accordance with the feature information extracted by the feature information extracting means, an alternative content whose subject is similar to or corresponds to a subject at the reproduction position of the content from said one or said plurality of content sources for supplying a content usable by the bookmark using device.

27. The bookmark using device as set forth in claim 26, further comprising reproduction position specifying means for specifying, in accordance with the feature information, a reproduction position of the alternative content at which reproduction position a subject of the alternative content is similar to or corresponds to the subject at the reproduction position of the content.

28. The bookmark using device as set forth in claim 25, further comprising bookmark update means for generating an alternative bookmark including at least an alternative content retrieval address used in retrieving an alternative content detected by the alternative content detecting means.

29. The bookmark using device as set forth in claim 27, further comprising bookmark update means for generating an alternative bookmark including at least (i) an alternative content retrieval address used in retrieving an alternative content detected by the alternative content detecting means and (ii) alternative reproduction position information indicative of a reproduction position of the alternative content which reproduction position is specified by the reproduction position specifying means.

30. The bookmark using device as set forth in claim 28, wherein the bookmark update means adds information on the alternative content which is included in the generated alternative bookmark to the bookmark as an original so that the bookmark is updated to be an updated bookmark.

31. The bookmark using device as set forth in claim 30, wherein the bookmark update means transmits the updated bookmark to a bookmark creation device having generated the bookmark as an original so as request the bookmark creation device to update the bookmark as an original.

32. The bookmark using device as set forth in claim 29, wherein the bookmark update means adds information on the alternative content which is included in the generated alternative bookmark to the bookmark as an original so that the bookmark is updated to be an updated bookmark.

33. The bookmark using device as set forth in claim 32, wherein the bookmark update means transmits the updated bookmark to a bookmark creation device having generated the bookmark as an original so as request the bookmark creation device to update the bookmark as an original.

34. The bookmark using device as set forth in claim 25, wherein
the feature information included in the bookmark includes text information indicative of the subject of the content, and
the alternative content detecting means uses a character sequence in the text information as a search query so as to detect an alternative content similar to or corresponding to the content as an original.

35. The bookmark using device as set forth in claim 25, further comprising a content retrieval information storage section for storing authentication information necessary for accessing said one or said plurality of content sources,
the alternative content detecting means accessing each of said one or said plurality of content sources by using the authentication information stored in the content retrieval information storage section.

36. The bookmark using device as set forth in claim 25, wherein
the feature information included in the bookmark includes image data of the content, and
the alternative content detecting means uses as a search query an image characteristic extracted from the image data so as to detect an alternative content similar to or corresponding to the content as an original.

37. The bookmark using device as set forth in claim 27, wherein
the feature information included in the bookmark includes image data at the reproduction position of the content, and
the reproduction position specifying means specifies, in accordance with an image characteristic extracted from the image data, a reproduction position of the alternative content which reproduction position is similar to or corresponds to the reproduction position of the content as an original.

38. A bookmark creation device, comprising:
content retrieval means for retrieving a content from a content source which supplies a content usable by the bookmark creation device;
feature information generating means for generating, from the content retrieved by the content retrieval means, feature information indicative of a subject of the content; and
bookmark generating means for generating a bookmark including at least (i) a content retrieval address used when the content retrieval means retrieves the content and (ii) the feature information generated by the feature information generating means.

39. The bookmark creation device as set forth in claim 38, wherein the bookmark generated by the bookmark generating means further includes reproduction position information indicative of a reproduction position of the content which reproduction position is specified by a user.

40. The bookmark creation device as set forth in claim 39, wherein the feature information generating means generates feature information indicative of a subject at the reproduction position of the content which reproduction position is specified by the user.

41. The bookmark creation device as set forth in claim 39, wherein the feature information generating means continuously or periodically extracts specific text information of the content as well as the reproduction position information of the content, and generates feature information on a reproduction position at which the text information changes.

42. The bookmark creation device as set forth in claim 38, wherein the feature information generating means generates feature information based on meta information which is associated with the content and which regards the content.

43. The bookmark creation device as set forth in claim 38, wherein the feature information generating means generates feature information by extracting text information from image data of the content.

44. The bookmark creation device as set forth in claim 38, wherein the feature information generating means generates feature information by extracting text information from audio data of the content.

45. The bookmark creation device as set forth in claim 38, wherein the feature information generating means generates feature information which is image data extracted from the content or information indicative of a location where the image data is stored.

46. A bookmark sharing system, comprising:
a bookmark creation device as set forth in claim 38;
a bookmark management server for storing and managing a bookmark generated by the bookmark creation device; and
a bookmark using device for retrieving a bookmark from the bookmark management server and using the bookmark, the bookmark using device including feature information extracting means for extracting a feature information indicative of a subject of a content from a bookmark including at least (i) a content retrieval address used in retrieving the content and (ii) the feature information; and
alternative content detecting means for detecting, in accordance with the feature information extracted by the feature information extracting means, an alternative content whose subject is similar to or corresponds to the subject of the content from one or a plurality of content sources for supplying a content usable by the bookmark using device.

47. A method for controlling a bookmark using device which uses a bookmark including at least (i) a content retrieval address used in retrieving a content and (ii) feature information indicative of a subject of the content,
the method comprising the steps of:
(a) extracting the feature information from the bookmark; and
(b) detecting, in accordance with the feature information extracted in the step (a), an alternative content whose subject is similar to or corresponds to the subject of the content from one or a plurality of content sources for supplying a content usable by the bookmark using device.

48. A method for controlling a bookmark creation device, comprising the steps of:
(a) retrieving a content from a content source which supplies a content usable by the bookmark creation device;
(b) generating, from the content retrieved in the step (a), feature information indicative of a subject of the content; and
(c) generating a bookmark including at least (i) a content retrieval address used when the content is retrieved in the step (a) and (ii) the feature information generated in the step (b).

49. A non-transitory computer-readable storage medium in which a control program for causing a computer to function as means of a bookmark using device as set forth in claim 25 is stored.

50. A non-transitory computer-readable storage medium in which a control program for causing a computer to function as means of a bookmark creation device as set forth in claim 38 is stored.
